(19) United States
(12) Patent Application Publication
(10) Pub. No.: US 2009/0224217 A1
(43) Pub. Date: Sep. 10, 2009

(54) CELLULOSE ACYLATE FILM, OPTICALLY COMPENSATORY FILM, POLARIZING PLATE AND LIQUID CRYSTAL DISPLAY

(75) Inventors: Hajime Nakayama, Kanagawa (JP); Yousuke Nishiura, Kanagawa (JP); Takako Nishiura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/817,327

(22) PCT Filed: Apr. 6, 2006
(86) PCT No.: PCT/JP2006/307870

§ 371 Date: Aug. 29, 2007

(30) Foreign Application Priority Data
Apr. 7, 2005 (JP) 2005-111171

(51) Int. Cl. G02C 7/12; C08B 3/16; B28B 1/14; B32B 23/20; C09D 101/10; G02B 1/10

(52) U.S. Cl. 252/585; 536/64; 264/299; 428/220; 106/168.01; 359/507

(57) ABSTRACT

A cellulose acylate film is provided and contains an additive. Tg of the cellulose acylate film is lower by 5 to 50° C. or the half value width of the diffraction peak at 2θ=10 to 15° in the X-ray diffraction pattern of the cellulose acylate film after heating at 200° C. for 3 hours is 110 to 300%, each compared with a cellulose acylate film not containing the additive. An optically compensatory film, and a polarizing plate and a liquid crystal display using the film are provided.

### TECHNICAL FIELD

The invention relates to a cellulose acylate film useful in liquid crystal displays and, moreover, to optical materials such as an optically compensatory film and a polarizing plate and a liquid crystal display using the same.

### BACKGROUND ART

Because of being excellent in transparency and free from optical defects, cellulose acylate films have been employed as protective films for polarizing plate which is one of members constituting a liquid crystal display. In general, a polarizing plate is obtained by dyeing a stretched polyvinyl alcohol (PVA)-based film with iodine or a dichroic dye to give a polarizer and stacking a protective film on at least one side thereof. Cellulose acylate films, in particular, triacetyl cellulose acylate films which can be stacked directly on PVA are employed in may cases.

Since the characteristics of a liquid crystal display largely depend on the optical characteristics of a protective film of a polarizer, requirement for the improvement in the qualities thereof is growing year by year. In liquid crystal displays in these days, it is more strongly required to improve the display performance in looking from an angle, i.e., the viewing angle characteristics. To improve the viewing angle characteristics, it is important to have an appropriate retardation value represented by the product of the birefringence and thickness of a protective film of a polarizing plate and another optical film employed. It has been a practice to employ an optically compensatory film for this purpose.

In order to control the retardation value by using an optically compensatory film, it is desirable to minimize the retardation value of a protective film with avoiding excess. In a protective film, it is particularly advantageous for improving the viewing angle-dependency to lower not only the in-plane retardation value (Re) but also the thickness direction retardation value (Rth).

Although there have been produced cellulose acylate films having a small in-plane retardation Re, a cellulose acylate film having a small Rth can be hardly produced. In recent years, there have been proposed optically transparent films having small thickness direction retardation value Rth with the use of a polycarbonate-based film or a thermoplastic cycloolefin film (see, for example, JP-A-2001-318233 and JP-A-2001-328233; examples of commercially available products being ZEONOR (manufactured by ZEON CORPORATION) and ARTON (manufactured by JSR)). These films are characterized by being advantageous in showing small dimensional change and low vapor transmission rate. In the case of using as a protective film of a polarizer, however, these optically transparent films suffer from a problem that they cannot be directly stacked on hydrophilic PVA because of the hydrophobic nature thereof. Moreover, there still remains another problem that the optical characteristics in the entire film face are uneven.

Furthermore, these polycarbonate-based films and cycloolefin-based films largely differ in physical properties from cellulose acylate films having been employed as protective films of polarizing plates hitherto, which bring about another industrial disadvantage that the existing equipment for manufacturing polarizing plates should be renewed.

On the other hand, it is required to improve the physical stability of cellulose acylate films and, therefore, the dimensional change and vapor transmission rate should be lowered.

### DISCLOSURE OF THE INVENTION

An object of an illustrative, non-limiting embodiment of the invention is to provide a cellulose acylate film which has small Re and Rth and is excellent in physical characteristics, in particular, showing a small dimensional change. Another object of an illustrative, non-limiting embodiment of the invention is to construct a protective film of a polarizing plate or an optically compensatory film being excellent in viewing angle characteristics and provide a liquid crystal display with the use of the same.

By adding a compound in a controlled amount to cellulose acylate, the inventors regulated the glass transition temperature (Tg) of a film to a level lower by 5 to 50° C. than the glass transition temperature of a film not containing the above compound. By elevating the half value width of the X-ray diffraction peak of the former film to 110 to 300% of the half value width of the film not containing the compound, appropriate crystallization was achieved within the film. Owing to these factors, the physical characteristics (dimensional change, modulus of elasticity, vapor transmission rate, etc.) of the cellulose acylate film of the invention could be improved compared with the film not containing the additive. By employing an additive by which the physical characteristics of the film can be improved and Re and Rth can be lowered, a cellulose acylate film having practically usable physical characteristics and optical characteristics favorable in using in liquid crystal displays and so on could be successfully produced.

The invention has been completed based on the following <1> to <28>.

<1> A cellulose acylate film comprising an additive, the cellulose acylate film fulfilling at least one of requirements (1) and (2):

(1) the cellulose acylate film has a glass transition temperature lower by 5 to 50° C. than that of a cellulose acylate film not containing the additive; and

(2) the cellulose acylate film having been heated at 200° C. for 3 hours has a half value width of a diffraction peak at 20 of 10 to 15° in an X-ray diffraction pattern thereof, the half value width being 110 to 300% of a half value width of a cellulose acylate film not containing the additive and having been heated at 200° C. for 3 hours, and (3) the cellulose acylate film further fulfilling numerical formulae (1) and (2).

0≦Re₆₃₀≦10, and |Rth₆₃₀|≦25 Numerical formulae (1)

|Re₄₀₀−Re₇₀₀|≦10, and |Rth₄₀₀−Rth₇₀₀|≦35 Numerical formulae (2)

wherein Re(λ) indicates an in-plane retardation (expressed in nm) of the cellulose acylate film at a wavelength of λ (nm); and Rth(λ) indicates a thickness-direction retardation (expressed in nm) of the cellulose acylate film at a wavelength of λ (nm).
<2> The cellulose acylate film as described in <1>, which has an absolute value of dimensional change after standing at 60° C. and 90% for 24 hours, the absolute value being 5 to 90% with respect to an absolute value of dimensional change of a cellulose acylate film not containing the additive.
<3> The cellulose acylate film as described in <1> or <2>, which has a modulus of elasticity of 101 to 150% with respect to a modulus of elasticity of a cellulose acylate film not containing the additive.
<4> The cellulose acylate film as described in any one of <1> to <3>, which has a photoelasticity of 105 to 150% with respect to a photoelasticity of a cellulose acylate film not containing the additive.
<5> The cellulose acylate film as described in any one of <1> to <4>, which has a density of 99.9% or less with respect to a density of a cellulose acylate film not containing the additive.
<6> The cellulose acylate film as described in any one of <1> to <5>, which has a vapor transmission rate of 30 to 90% with respect to a vapor transmission rate of a cellulose acylate film not containing the additive.
<7> The cellulose acylate film as described in any one of <1> to <6>, which has a contact angle after alkali saponification of 95% or less with respect to a contact angle after alkali saponification of a cellulose acylate film not containing the additive.
<8> The cellulose acylate film as described in any one of <1> to <7>, which has a tear strength of 95% or less with respect to a tear strength of the cellulose acylate film not containing the additive.
<9> The cellulose acylate film as described in any one of <1> to <8>, which has a coefficient of humidity expansion of 95% or less with respect to a coefficient of humidity expansion of a cellulose acylate film not containing the additive.

<10> The cellulose acylate film as described in any one of <1> to <9>, which is obtained from a starting polymer having an acylation ratio of 2.85 to 3.00.

<11> The cellulose acylate film as described in any one of <1> to <10>, wherein the additive is a compound capable of lowering Rth_{λ} in such a range as fulfilling the following numerical formulae (3) and (4):

(Rth_{λA}−Rth_{λ0})/A≦<−1.0 Numerical formula (3)

0.01≦A≦30 Numerical formula (4)

wherein Rth_{λA} indicates Rth_{λ} (nm) of a cellulose acylate film containing A % by mass (weight) of the compound capable of lowering Rth_{λ}; Rth₀ indicates Rth_{λ} (nm) of a cellulose acylate film not containing the compound capable of lowering Rth_{λ}; and A indicates an amount of the compound capable of lowering Rth_{λ} expressed in mass (%) referring the mass of the polymer material of the cellulose acylate film as to 100.
<12> The cellulose acylate film as described in <11>, wherein the compound capable of lowering Rth_{λ} has an octanol-water partition coefficient (log P value) of 0 to 7.
<13> The cellulose acylate film as described in <11> or <12>, wherein the compound capable of lowering Rth_{λ} is a compound represented by formula (1) or (2):

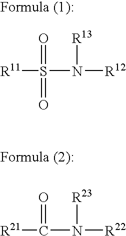

wherein R¹¹ represents an alkyl group or an aryl group; R¹² and R¹³ each independently represents a hydrogen atom, an alkyl group or an aryl group; R²¹ represents an alkyl group or an aryl group; and R²² and R²³ each independently represents a hydrogen atom, an alkyl group or an aryl group.
<14> The cellulose acylate film as described in any one of <1> to <13>, wherein the additive is a compound capable of lowering |Re₄₀₀−Re₇₀₀ | and |Rth₄₀₀-400−Rth₇₀₀| in an amount of 0.01 to 30% by mass based on a solid content of a starting polymer of the cellulose acylate film.
<15> The cellulose acylate film as described in any one of <1> to <14>, which has a spectral transmittance at the wavelength of 380 nm of 45 to 95% and a spectral transmittance at the wavelength of 350 of 10% or less.
<16> The cellulose acylate film as described in any one of <1> to <15>, which has a film thickness of 10 to 120 μm.
<17> A method of producing a cellulose acylate film as described in any one of <1> to
<16>, which comprises: casting a cellulose acylate solution on a support to provide a film; stripping off the film from the support; and drying the film, wherein the amount of the solvent remaining in the film at the stripping is 50 to 200%.
<18> A method of producing a cellulose acylate film as described in any one of <1> to <16>, which comprises: casting a cellulose acylate solution on a support to provide a film; stripping off the film from the support; and drying the film at a temperature of 120 to 160° C.
<19> An optically compensatory film comprising: a cellulose acylate film as described in any one of <1> to <16>; and an optically anisotropic layer having Re₆₃₀ of 0 to 200 nm and |Rth₆₃₀| of 0 to 400 nm.
<20> The optically compensatory film as described in <19>, wherein the optically anisotropic layer contains a discotic liquid crystal layer.
<21> The optically compensatory film as described in <19> or <20>, wherein the optically anisotropic layer contains a rod-shaped liquid crystal layer.
<22> The optically compensatory film as described in any one of <19> to <21>, wherein the optically anisotropic layer contains a polymer film.
<23> The optically compensatory film ac described in <22>, wherein the polymer film constituting the optically anisotropic layer contains at least one polymer material selected from the group consisting of polyamide, polyimide, polyester, polyetherketone, polyamidimde, polyesterimide and polyaryl-ether ketone.
<24> A polarizing plate comprising: a polarizer; and a protective film being at least one cellulose acylate film as described in any one of [1] to [16] or an optically compensatory film as described in any one of [19] to [23].
<25> The polarizing plate as described in <24>, which has at least one layer on a surface thereof, the at least one layer being selected form the group consisting of a hard coat layer, an antiglare layer and an antireflection layer.
<26> A liquid crystal display comprising a cellulose acylate film as described in any one of <1> to <16>, a optically compensatory film as described in any one of <19> to <23> or a polarizing plate as described in <24> or <25>.
<27> The liquid crystal display as described in <26>, which is a VA liquid crystal display or an IPS liquid crystal display.
<28> The liquid crystal display as described in [27], which is an IPS liquid crystal display, wherein the liquid crystal display comprises a liquid crystal cell; two polarizing plates, one of the two pnolarizing plate being in the top side of the liquid crystal, the other of the two polarizing plate in the bottom side of the liquid crystal cell, and at least one of the two polarizing plates having a cellulose acylate film as described in any one of <1> to <16>.

Use of a cellulose acylate film of the invention, which has improved physical properties such as film dimensional change, modulus of elasticity and vapor transmission rate and lowered Re and Rth, makes it possible to construct a protective film of a polarizing plate or an optically compensatory film having excellent viewing angle characteristics. Moreover, it is effective to employ a cellulose acylate film of the invention in an IPS mode liquid crystal display, since color change in looking from an angle can be lessened and light leakage in the black display can be relieved thereby. In the case of using a cellulose acylate film of the invention in a VA mode liquid crystal display, the contrast viewing angle characteristics in looking from an angle can be improved.

### BRIEF DESCRIPTION OF DRAWING

FIG. 1 is a schematic view showing an IPS mode liquid crystal display provided with an exemplary cellulose acylate film of the invention.

### DETAILED DESCRIPTION OF THE INVENTION

### Best Mode for Carrying Out the Invention

Exemplary embodiments of the invention will be illustrated in greater detail.

### <Cellulose Acylate Film>

As mentioned above in <1>, a cellulose acylate film of the invention is a cellulose acylate film containing an additive which is characterized by satisfying at least one of the two requirements (1) and (2) and also satisfying the requirement (3).

The requirement (1) in the above <1> is a cellulose acylate film containing an additive wherein the glass transition temperature (hereinafter referred to as Tg) of the cellulose acylate film is lower by 5 to 50° C. than Tg of a cellulose acylate film not containing the additive. It is preferable that the former Tg is lower by 10 to 50° C., more preferably 15 to 50° C., than the latter Tg.

As the results of intensive studies, the inventor has succeeded in regulating Tg within the range as defined above by selecting an appropriate type of additive and controlling the content of the additive. In general, Tg is lowered and the film is softened with an increase in the content of the additive. In the invention, Tg is regulated within the desired range as defined above by avoiding to use the additive in excess and preventing excessive lowering in Tg. As a result, the cellulose acylate film of the invention has improved physical properties compared with the film before the addition of the additive.

So long as the lowering in Tg of the cellulose acylate film containing the additive of the invention is 5° C. or more compared with Tg of the cellulose acylate film not containing the additive, the additive is highly compatible with cellulose acylate and well dissolved therein, thereby giving a stable dope solution. Owing to the additive contained in an appropriate amount, the film has an adequately hydrophobic nature and thus dimensional change due to change in humidity can be maintained at a low level. In this case, furthermore, the film is neither too hard, fragile nor easily torn and there arises no problem in the physical characteristics of the film. So long as the lowering is not more than 50° C., the film would not suffer from troubles in physical characteristics (for example, worsening in elasticity or worsening in heat resistance). Therefore, it causes no serious worsening in performance when employed in a liquid crystal display, etc.

In the invention, Tg is defined in accordance with JIS K-7121.

The requirement (2) in the above <1> is a cellulose acylate film containing an additive wherein the half value width of the diffraction peak at 2θ=10 to 15° in the X-ray diffraction pattern of the cellulose acylate film, which has been heated at 200° C. for 3 hours, is 110 to 300% of the half value width of the cellulose acylate film not containing the additive which has been heated at 200° C. for 3 hours. It is preferable that the former half value width is 110 to 250%, more preferably 110 to 200%, of the latter half value width. This fact indicates that, when the diffraction peak of the cellulose acylate film containing the additive of the invention is compared with the diffraction peak of the cellulose acylate film not containing the additive, the diffraction peak is elevated. This means that, in the cellulose acylate film containing the additive of the invention, the regularly repeated structure forming the diffraction peak is remarkable compared with the cellulose acylate film not containing the additive.

So long as the half value width of the diffraction peak at 2θ=10 to 15° in the X-ray diffraction pattern of the cellulose acylate film falls within the range as defined above compared with the half value width of the cellulose acylate film not containing the additive which has been heated at 200° C. for 3 hours, the film contains a repeated regular structure forming the diffraction peak at an appropriate level and thus the physical characteristics (for example, dimensional change, modulus of elasticity, vapor transmission rate and so on) can be improved.

The requirement (3) in the above <1> is a cellulose acylate film containing an additive and the optical performance of the film fulfills the following numerical formulae (1) and (2):

0≦Re₆₃₀≦10, and |Rth₆₃₀|≦25 Numerical formulae (1)

|Re₄₀₀−Re₇₀₀|≦10, and |Rth₄₀₀−Rth₇₀₀|≦35 Numerical formulae (2)

In the above formulae, Re₆₃₀, Re₄₀₀ and Re₇₀₀ indicate the in-plane retardations (expressed in nm) of the cellulose acylate film at wavelength of 630 nm, 400 nm and 700 nm respectively; and Rth₆₃₀, Rth₄₀₀ and Rth₇₀₀ indicate thickness-direction retardations (expressed in nm) of the cellulose acylate film at wavelength of 630 nm, 400 nm and 700 nm respectively.

To improve the viewing angle dependency in a liquid crystal display, it is preferable that the optical performance of the cellulose acylate film containing the additive fulfills the following numerical formulae (1′) and (2′), more preferably (1″) and (2″).

0≦Re₆₃₀≦8, and |Rth₆₃₀≦23; Numerical formula (1′)

|Re₄₀₀−Re₇₀₀|≦8, and |Rth₄₀₀−Rth₇₀₀|≦30. Numerical formula (2′)

0≦Re₆₃₀≦5, and |Rth₆₃₀|≦30; Numerical formula (1″)

|Re₄₀₀−Re₇₀₀|<5, and |Rth₄₀₀−Rth₇₀₀≦25. Numerical formula (2″)

As discussed above, the cellulose acylate film containing the additive of the invention should fulfill at least one of (1) and (2), among the three requirements as described above, to improve the physical characteristics and also fulfill the requirement (3) to improve the viewing angle characteristics.

### (Evaluation of the Performance of Cellulose Acylate Film)

### (Measurement of Retardation)

### (In-Plane Retardation Re and Thickness-Direction Retardation Rth)

After conditioning a sample (30 mm×40 mm) at 25° C. and 60% RH for 2 hours, Re? is measured by the incidence of a ray of λ nm in wavelength in the normal direction with the use of an automatic double refractometer KOBRA 21 ADH (manufactured by OJI KEISOKU KIKI). Rth_{λ} is calculated based on retardation values including Re_{λ} as described above and retardation values measured by the incidence of a ray of λ nm in wavelength in directions inclining to 40° at intervals of 10° to the normal direction (i.e., 0°) of the film using the slow axis in the plane by inputting a presumptive average refractive index (1.48) and the film thickness.

### (Measurement of Wavelength Dispersion of Re and Rth)

After conditioning a sample (30 mm×40 mm) at 25° C. and 60% RH for 2 hours, Re is at each wavelength is measured by the incidence of rays of 780 nm to 380 nm in wavelength in the normal direction of the film with the use of an ellipsometer (M150 manufactured by JASCO ENGINEERING). Thus, the wavelength dispersion of Re is determined. On the other hand, the wavelength dispersion of Rth is determined based on three retardation values measured in three directions, i.e., the Re as obtained above, a retardation value measured by the incidence of rays of 780 to 380 nm in wavelength in a direction inclining at +40° to the normal direction of the film using the slow axis in the plane as the incline angle and a retardation value measured by the incidence of rays of 780 to 380 nm in wavelength in a direction inclining at −40° to the normal direction of the film using the slow axis in the plane as the incline angle and inputting a presumptive average refractive index (1.48) and the film thickness.

It is preferable that the absolute value of the dimensional change after standing at 60° C. and 90% for 24 hours of the cellulose acylate film containing the additive of the invention is from 5 to 90% of the absolute value of dimensional change the cellulose acylate film not containing the additive. It is still preferable that the former absolute value is from 5 to 80%, more preferably from 5 to 70%, of the latter.

The dimensional change is measured in practice by preparing a cellulose acylate film sample (30 mm×120 mm; referring the machine direction (MD) as the long side), conditioning the sample at 25° C. and 60% RH for 24 hours, punching holes of 6 mm in diameter at intervals of 100 mm on both edges of the sample by using an automatic pin gauge (manufactured by SHINTO SCIENCE Co., Ltd.) and referring the intervals among the holes as the original size (L0). Next, the sample is treated at 60° C. and 90% RH for 24 hours and the intervals among the holes (L1) are measured. Each measurement is made to the minimum scale value of 1/1000 mm. After standing at 60° C. and 90% RH for 24 hours, the dimensional change rate is determined as follows. Dimensional change rate={|L0−L1|/L0}×100. Subsequently, the ratio of the absolute value of the dimensional change rate of the cellulose acylate film containing the additive to that of the cellulose acylate film not containing the additive is calculated.

It is preferable that the modulus of elasticity of the cellulose acylate film containing the additive of the invention is from 101 to 150% of the modulus of elasticity of the cellulose acylate film not containing the additive. It is still preferable that the former modulus of elasticity is from 105 to 140%, more preferably from 110 to 130%, of the latter. The modulus of elasticity is determined in practice by measuring the stress at a 0.5% elongation at a tensile speed of 10%/min in an atmosphere at 23° C. and 70% RH with the use of a multipurpose tensile test machine STM T50BP (manufactured by TOYO BALDWIN).

So long as the modulus of elasticity of the cellulose acylate film containing the additive falls within the range as defined above based on the modulus of elasticity of the cellulose acylate film not containing the additive, the film suffers from no problem in physical characteristics. When it is employed in a liquid crystal display, etc., moreover, there arises no remarkable worsening in performance.

It is preferable that density of the cellulose acylate film containing the additive of the invention is not more than 99.9% of the density of the cellulose acylate film not containing the additive. The density is determined in practice by conditioning the sample at a temperature of 25° C. and a humidity of 50% RH for 24 hours and then measuring the density thereof in a density gradient tube (n-heptane/carbon tetrachloride) at 25° C.

It is preferable that the vapor transmission rate of the cellulose acylate film containing the additive of the invention is from 30 to 90% of the vapor transmission rate of the cellulose acylate film not containing the additive. It is still preferable that the former vapor transmission rate is from 30 to 80%, more preferably from 30 to 70%, of the latter. It is preferred that the vapor transmission rate of the cellulose acylate film containing the additive is not more than 90% of the vapor transmission rate of the cellulose acylate film not containing the additive, since the Re and Rth values of the film do not vary in this case. It is preferred that the vapor transmission rate of the cellulose acylate film containing the additive is 30% or more of the vapor transmission rate of the cellulose acylate film not containing the additive, since no problem (adhesion failure, etc.) occurs in the case of constructing a polarizing plate by laminating the cellulose acylate film of the invention on a polarizer as a protective film of a polarizing plate.

The vapor transmission rate is measured at a temperature of 60° C. and a humidity of 95% RH in accordance with JIS Z-0208. As a method of measuring the vapor transmission rate, use can be made of a method described in Kobunshi no Bussei II (Kobunshi Jikken Koza 4, Kyoritsu Shuppan), p, 285 to 294: Joki Tokaryo no Sokutei(Shisuryo-ho, Ondokei-ho, Jokiatsu-ho, Kyuchaku-ho). A sample (70 mm in diameter) of the cellulose acylate film of the invention is conditioned at 25° C. and 90% RH and 95% RH each for 24 hours and then the moisture content per unit area (g/m²) is calculated in accordance with JIS Z-0208 by using a vapor transmission rate tester “KK-709007” (manufactured by TOYO SEIKI). Then the vapor transmission rate is determined as follows: vapor transmission rate=(mass after conditioning)−(mass before conditioning).

In the case of using the cellulose acylate film of the invention as a transparent protective film for a polarizing plate, alkali saponification of the cellulose acylate film surface may be cited as an effective means of laminating the cellulose acylate film on the polarizing plate. By the alkali saponification, the cellulose acylate film surface becomes hydrophilic and the contact angle to water is reduced. It is preferable that the contact angle of the alkali-saponified cellulose acylate film of the invention is from 95% to 0% of the contact angle of the cellulose acylate film not containing the additive. It is still preferable that the former contact angle is from 90% to 0%, more preferably from 85% to 0%, of the latter. To evaluate the contact angle, the hydrophilic/hydrophobic nature is examined by a conventionally employed method which comprises dropping a water droplet of 3 mm in diameter on the surface of the alkali-saponified film and measuring the angle between the film surface and the water droplet.

It is preferable that the tear strength of the cellulose acylate film containing the additive of the invention is not more than 95% of the tear strength of the cellulose acylate film not containing the additive. It is still preferable that the former tear strength is from 5 to 90%, more preferably from 10 to 85%, of the latter. To achieve stable handling properties during the film production and polarizing plate processing, a film should have an appropriate hardness, which can be almost substituted by the tear strength of the film. So long as the tear strength of the cellulose acylate film containing the additive is not less than the lower limit as defined above, there arises no such problem in the production that the film easily tears in the course of the production. On the other hand, it is preferable that the tear strength is not less than the upper limit as defined above, since there arises no such problem that the film becomes too hard and thus suffers from troubles in traveling along a curved roll during the film production and polarizing plate processing. The tear strength can be determined in practice in accordance with the tear test as defined in JIS K-7128-2:1998 (Elmendorf tear method) comprising conditioning a sample piece (50 mm×64 mm) at 25° C. and 65% RH for 2 hours and then measuring the tear strength with the use of a light-load tear strength tester.

It is preferable that the coefficient of humidity expansion of the cellulose acylate film containing the additive of the invention is from 95% to 0% of the coefficient of humidity expansion of the cellulose acylate film not containing the additive. It is still preferable that the former coefficient of humidity expansion is from 90% to 0%, more preferably from 85% to 0%, of the latter. Coefficient of humidity expansion means a change in the length of a sample caused by a change in the relative humidity at a constant temperature. By controlling coefficient of humidity expansion, frame-shaped increase in transmittance, i.e., light leakage caused by strain can be prevented in the case of using the cellulose acylate film of the invention as a member of a liquid crystal display. The coefficient of humidity expansion is measured in practice by preparing a sample (20×5 mm), increasing the humidity from 15% RH to 90% RH at a constant temperature of 60° C. and employing the value at 60% RH.

### (Cellulose Acylate)

### (Starting Cotton Material for Synthesizing Cellulose Acylate)

Examples of the starting cellulose to be used for synthesizing the cellulose acylate in the invention include cotton linter and wood pulp (hardwood pulp and softwood pulp). Use can be made of cellulose acylate obtained from any cellulose material and a mixture is also usable in some cases. These starting cotton materials are described in detail in, for example, Purasuchikku Zairyo Koza (17), Senisokei Jushi (Marusawa and Uda, The Nikkan Kogyo Shinbun, Ltd., 1970) and Japan Institute of Invention and Innovation Journal of Technical Disclosure No. 2001-1745, p. 7 to 8, though the material of the cellulose acylate film of the invention is not particularly restricted thereto.

### (Degree of Substitution in Cellulose Acylate)

A cellulose acylate which is produced starting with the cellulose material as described above will be illustrated. In the cellulose acylate in the invention, hydroxyl groups in cellulose have been acylated. As the substituents, use may be made of acetyl groups having from 2 to 22 carbon atoms. In the cellulose acylate to be used in the invention, the degree of substitution of hydroxyl groups in the cellulose is not particularly restricted. The substitution degree can be determined by measuring the degree of binding of acetic acid and/or fatty acids having from 3 to 22 carbon atoms substituting hydroxyl groups in cellulose and calculating. The measurement can be carried out in accordance with ASTM D-817-91.

In the cellulose acylate film of the invention, Re and Rth originating in the cellulose main chain can be more compensated by acyl substituent side chains at a higher acylation ratio, thereby lowering Re and Rth. That is to say, the amount of the compound capable of lowering Rth as an additive can be lowered by using cellulose acylate having a high acylation ratio as the starting material (starting polymer) and, in its turn, an extreme lowering in Tg caused by the excessive use of the additive can be prevented. More specifically speaking, it is preferable that the acylation ratio of the starting polymer for the cellulose acylate film of the invention is from 2.85 to 3.00, more preferably from 2.90 to 3.00. The term “acylation ratio” as used herein means the total degree of substitution, i.e., indicating the sum of the substitution degrees in the case of having a mixture of substituents of different types.

Among the acetic acid or fatty acids having from 3 to 22 carbon atoms substituting hydroxyl groups in cellulose, the acyl group having from 2 to 22 carbon atoms may be an aliphatic group or an allyl group without restriction. Either a single group or a mixture of two or more groups may be used. Use may be made of, for example, alkylcarbonyl esters, alkenylcarbonyl esters, aromatic carbonyl esters and aromatic alkylcarbonyl esters of cellulose each optionally having additional substituents. Preferable examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl and cinnamoyl groups. Among them, acetyl, propionyl, butanoyl, dodecanoyl, octadecanoyl, t-butanoyl, oleoyl, benzoyl, naphthylcarbonyl and cinnamoyl groups are preferable, and acetyl, propionyl and butanoyl groups are more preferable.

### (Organic Solvent of Cellulose Acylate Solution)

In the invention, it is preferred to produce the cellulose acylate film by the solvent casting method. In this method, a film is produced by using a cellulose acylate solution dissolved in an organic solvent (a dope). As preferable examples of organic solvents to be used as the main solvent in the invention, use may be preferably made of solvents selected from among esters, ketones and ethers having from 3 to 12 carbon atoms and halogenated hydrocarbons having from 3 to 12 carbon atoms and halogenated hydrocarbons having form 1 to 7 carbon atoms. These esters, ketones and ethers may have cyclic structure. It is also possible to use, as the main solvent, compounds having two or more functional groups (i.e., —O—, —CO— and —COO—) of esters, ketones and ethers and these compounds may have another functional group such as alcoholic hydroxyl group at the same time. In the case of a main solvent having two or more types of functional groups, the carbon atom number falling within the range as specified above concerning a compound having one of the functional groups.

As described above, the cellulose acylate film according to the invention may comprise, as the main solvent, either a chlorine-based halogenated hydrocarbon or a nonchlorinated organic solvent as described in Japan Institute of Invention and Innovation Journal of Technical Disclosure No. 2001-1745 (p. 12 to 16). The invention is not restricted thereto.

Other solvents for the cellulose acylate solution and film according to the invention and dissolution methods therefore are disclosed in the following patents which are preferred embodiments: for example, JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237816, JP-A-11-60807, JP-A-11-152342, JP-A-11-292988, JP-A-11-60752 and so on. According to these patents, not only preferable solvents but also solution properties thereof and substances to coexist are reported, thereby presenting preferred embodiments of the invention.

### (Process for Producing Cellulose Acylate Film)

### (Dissolution Step)

In preparing a cellulose acylate solution (dope) of the invention, the cellulose acylate is dissolved by an arbitrary method without restriction, i.e., by room-temperature dissolution, cold dissolution, hot dissolution or a combination thereof. Concerning the preparation of the cellulose acylate solution according to the invention, concentration of the solution in association with the dissolution and filtration, it is preferable to employ the process described in, for example, Japan Institute of Invention and Innovation Journal of Technical Disclosure No. 2001-1745 (2001 Mar. 15, Japan Institute of Invention and Innovation), p. 22 to 25.

### (Transparency of Dope Solution)

It is preferable that the transparency of the dope of the cellulose acylate solution according to the invention is 85% or higher, more preferably 88% or higher and more preferably 90% or higher. In the invention, it is confirmed that various additives have been sufficiently dissolved in the cellulose acylate dope solution. The dope transparency in practice is determined by pouring the dope solution into a glass cell (1 cm×1 cm), measuring the absorbance at 550 nm with a spectrophotometer (UV-3150, manufactured by Shimadzu), separately measuring the solvent alone as a blank, and then calculating the transparency based on the ratio to the absorbance of the blank.

### (Casting, Drying and Winding Steps)

Next, a method of producing a film by using the cellulose acylate solution (dope) of the invention will be illustrated.

Concerning a film-forming method and apparatus for producing the cellulose acylate film of the invention, use can be made of the solvent cast film-forming method and a solvent cast film-forming apparatus conventionally employed in forming cellulose triacetate films. A dope (a cellulose acylate solution) prepared in a dissolution machine (a pot) is once stored in a storage pot and, after defoaming, the dope is subjected to the final preparation. Then the dope is discharged from a dope exhaust and fed into a pressure die via, for example, a pressure constant-rate pump whereby the dope can be fed at a constant rate at a high accuracy depending on the rotational speed. From the pipe sleeve (slit) of the pressure die, the dope is uniformly cast onto a metallic support continuously running in the casting section. At the peeling point where the metallic support has almost rounded, the half-dried dope film (also called a web) is stripped off from the metallic support.

In the step or stripping off from the support, the degree of the drying and volatilization (the degree of half-drying) affects the physical properties of the final film product. More specifically speaking, the crystallization of the polymer chain proceeds to the higher extent at a higher drying speed and, as a result, the film becomes relatively hard. In such a case, the film properties such as dimensional change can be more improved. In the case where the film having been almost dried is stripped and then dried slowly, on the contrary, the crystallization of the polymer chain less proceeds and thus the film becomes relatively soft. To obtain a highly crystallized film showing an X-ray diffraction pattern falling within the desired range, it is preferred in the invention to strip off the film wherein the amount of the solvent remaining therein is 50% or more but not more than 200%. It is preferred that the amount of the solvent remaining at the stripping is 55% or more but not more than 180%, more preferably 60% or more but not more than 150%. The amount of the remaining solvent is represented by the following numerical formula (9). The remaining volatile mass means the value determined by subtracting the mass of the heated (2 hours at 120° C.) film from the film mass before heating.

amount of remaining solvent=(remaining volatile mass/heated film mass)×100(%) Numerical formula (9)

The obtained web is clipped at both ends and dried by carrying with a tenter while maintaining the width at a constant level. Subsequently, it is carried with rolls in a dryer to terminate the drying and then wound with a winder in a definite length.

Although the drying temperature may be optionally varied, it is found out that the optical performance of the cellulose acylate film of the invention can be controlled by drying at a higher temperature. By drying at a higher temperature, namely, the main chain and side chains of cellulose acylate are easily loosened. In particular, the degrees of freedom of side chains are elevated and thus the orientation in the film plane and the planar orientation in the film thickness direction are regulated. As a result, it becomes possible to lower both of Re and Rth. More specifically speaking, it is preferable to dry the film at 120 to 160° C., more preferably at 125 to 160° C. and more preferably at 130 to 160° C. By employing such drying conditions, the amount of the compound capable of lowering Rth as an additive can be lowered and, in its turn, an extreme lowering in Tg caused by the excessive use of the additive can be prevented.

Combination of the tenter and the rolls in the dryer may vary depending on the purpose. In the solvent cast film-forming method to produce functional protective films for electronic displays or silver halide photosensitive materials (i.e., the main uses of the cellulose acylate film of the invention), a coater is frequently employed, in addition to the solvent cast film-forming apparatus, so as to process the film surface by providing, for example, an undercoating layer, an antistatic layer, an anti-halation layer or a protective layer. These layers are described in detail in Japan Institute of Invention and Innovation Journal of Technical Disclosure No. 2001-1745 (2001 Mar. 15, Japan Institute of Invention and Innovation), p. 25 to 30. The techniques given in this document, which are itemized as casting (including co-casting), metallic supports, drying, peeling and so on, are preferably usable in the invention.

### (Additives to Cellulose Acylate)

To a cellulose acylate solution of the invention, it is possible to add various additives (for example, a compound capable of lowering Rth, a wavelength dispersion regulator, a UV-blocking agent, a plasticizer, an antidegradant, fine particles, an optical characteristic-controlling agent, etc.) depending on purpose in individual steps of the production. Now, these additives will be illustrated. These additives may be added in the step of preparing the dope. Alternatively, a step of adding the additives may be provided in the final step of preparing the dope.

(Compound capable of lowering Rth)

It is preferable that the cellulose acylate film of the invention contains at least one compound lowering the retardation value in the film thickness direction Rth (hereinafter referred to as a compound capable of lowering Rth) within a range fulfilling the following numerical formulae (3) and (4):

(Rth_{λA}−Rth_{λ0})/A≦<−1.0 Numerical formula (3)

0.01≦A≦30. Numerical formula (4)

It is preferable that the above numerical formulae (3) and (4) are:

(Rth_{λA}−Rth_{λ0})/A≦−2.0 Numerical formula (3-1)

(X)0.01≦A≦20. Numerical formula (4-1)

It is still preferable that the above numerical formulae (3) and (4) are:

(Rth_{λA}−Rth_{λ0})/A≦−3.0 Numerical formula (3-2)

0.01≦A≦15. Numerical formula (4-2)

In the above formulae, Rth_{λA} is Rth (nm) of a film containing A % by mass of the compound lowering Rth_{λ}; Rth_{λ0} is Rth (nm) of a film containing no compound lowering Rth_{λ}; and A is the mass (%) of the compound lowering Rth_{λ} referring the mass of the starting polymer for the film as to 100

### (Structural Characteristic of Rth-Lowering Agent)

Now, the compound capable of lowering Rth of cellulose acylate film will be illustrated.

To sufficiently lower the optical anisotropy and reduce both of Re and Rth close to zero, it is preferable to use a compound inhibiting the orientation of cellulose acylate in a film in plane and in the film thickness direction. For this purpose, it is advantageous to employ a compound lowering optical anisotropy which is sufficiently compatible with cellulose acylate and has neither a rod-like structure nor a planar structure by itself. In the case of having a plural number of planar functional groups such as aromatic groups, more specifically speaking, a nonplaner structure having these functional groups not on a single plane is advantageous.

### (Log P Value)

To produce the cellulose acylate film of the invention, it is preferable to employ, from among the compounds which prevent cellulose acylate in the film from orientation in-plane and in the film thickness direction to thereby lower Rth, a compound having an octanol-water partition coefficient (log P value) of from 0 to 7. A compound having a logp value not more than 7 has an excellent compatibility with cellulose acylate and thus never results in clouding or blooming of the film. A compound having a log P value not less than 0 has not excessively highly hydrophilic nature and thus never causes problems such as worsening the water resistance of the cellulose acylate film. It is still preferable that the log P value ranges from 1 to 6, especially preferably from 1.5 to 5.

The octanol-water partition coefficient (log P value) can be measured by the flask shaking method in accordance with JIS Z7260-107 (2000). It is also possible to estimate the octanol-water partition coefficient (log P value) by using not practical measurement but a computational or empirical method. As the computational method, use may be preferably made of Crippen's fragmentation method (J. Chem. Inf. Comput. Sci., vol. 27, p. 21 (1987)), Viswanadhan's fragmentation method (J. Chem. Inf. Comput. Sci., vol. 29, p. 163 (1989)), Broto's fragmentation method (Eur. J. Med. Chem.—Chim. Theor., vol. 19, p. 71 (1984)) and so on. It is still preferable to employ Crippen's fragmentation method. In the case where the log P value of a compound determined by the measurement method differs from its calculated value, it is favorable to judge whether or not the compound falls within the desired range with the use of Crippen's fragmentation method.

### (Physical Properties of Rth-Lowering Agent)

The Rth-lowering agent may either contain an aromatic group or not. It is preferable that the Rth-lowering agent has a molecular weight of 150 or more but not more than 3000, more preferably 170 or more but not more than 2000 and more preferably 200 or more but not more than 1000. So long as the molecular weight falls within this range, the compound may have either a specific monomer structure or an oligomer or polymer structure composed of a plural number of the monomer units bonded together.

It is preferable that the Rth-lowering agent is a liquid at 25° C. or a solid having a melting point of from 25 to 250° C. A compound which is a liquid at 25° C. or a solid having a melting point of from 25 to 200° C. is still preferred. It is also preferable that the Rth-lowering agent would not vaporize in the course of dope casting and drying in constructing the cellulose acylate film.

The Rth-lowering agent is added preferably in an amount of from 0.01 to 30% by mass, more preferably from 0.05 to 25% by mass and particularly preferably from 0.1 to 20% by mass based on the cellulose acylate.

A single compound may be used as the Rth-lowering agent. Alternatively, use can be made of a mixture of two or more compounds at an arbitrary ratio. The Rth-lowering agent may be added at any step in preparing a dope. It may be added at the final step of the dope preparation.

Preferable examples of the Rth-lowering agent include compounds represented by the following formula (1). Next, the compounds of the formula (1) will be described.

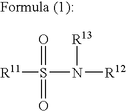

In the formula (1), R¹¹ represents an alkyl group or an aryl group; and R¹² and R¹³ each independently represents a hydrogen atom, an alkyl group or an aryl group. It is preferable that the sum of the carbon atoms in R¹¹, R¹² and R¹³ is 10 or more. These alkyl and aryl groups may have substituents.

Preferable examples of the substituents include a fluorine atom, alkyl groups, aryl groups, alkoxy groups, sulfone group and sulfonamido group. Among all, alkyl groups, aryl groups, alkoxy groups, sulfone group and sulfonamido group are particularly preferable The alkyl group may be either chain type, branched or cyclic. It is preferable that the alkyl group has from 1 to 25 carbon atoms, more preferably from 6 to 25 carbon atoms and especially preferably from 6 to 20 carbon atoms (for example, methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl and didecyl).

The aryl group preferably has from 6 to 30 carbon atoms, more preferably from 6 to carbon atoms (for example, phenyl, biphenyl, terphenyl, naphthyl, binaphthyl and triphenylphenyl). Next, preferable examples of the compounds represented by the formula (1) will be presented, though the invention is not restricted to these specific examples.

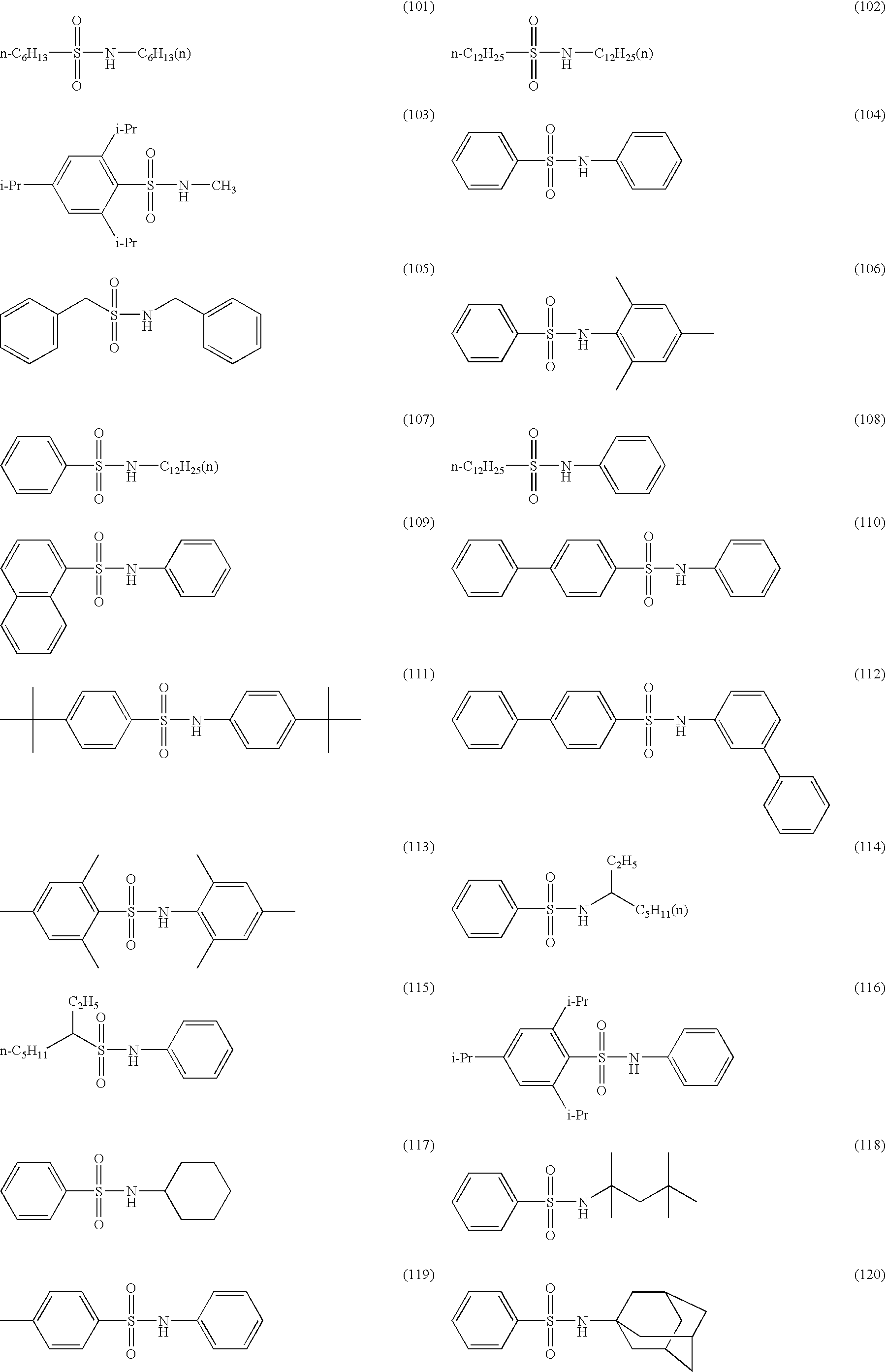

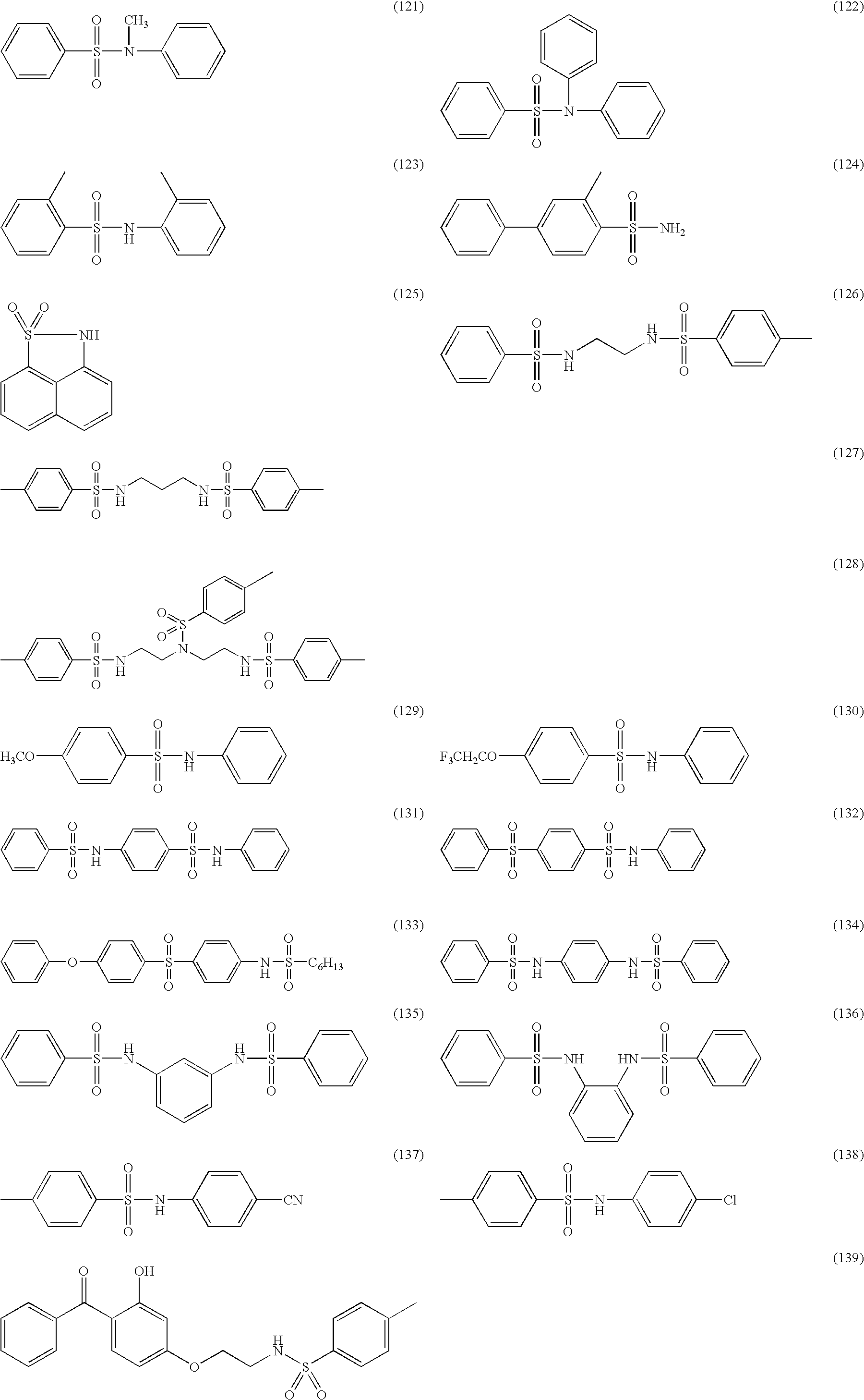

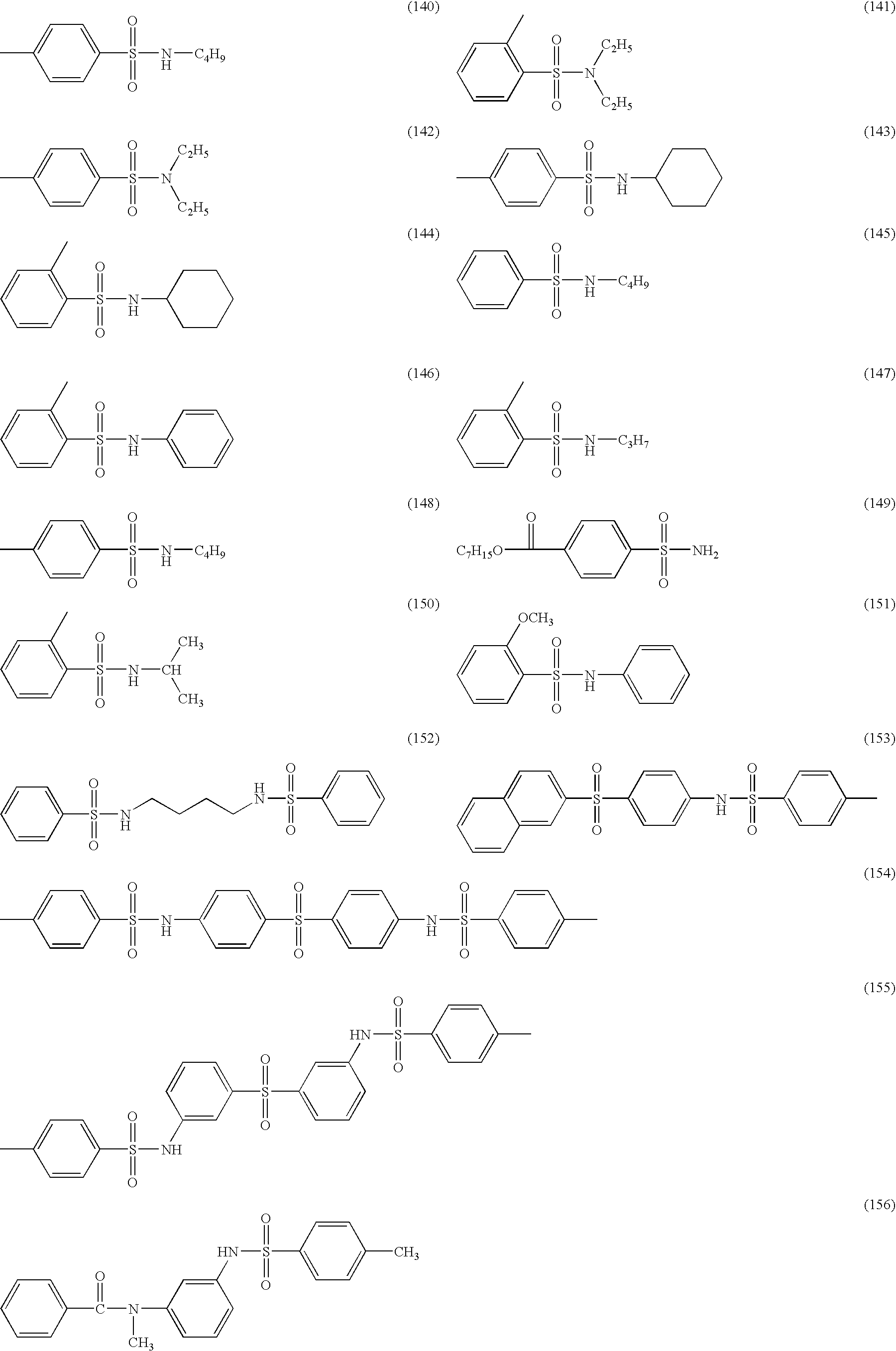

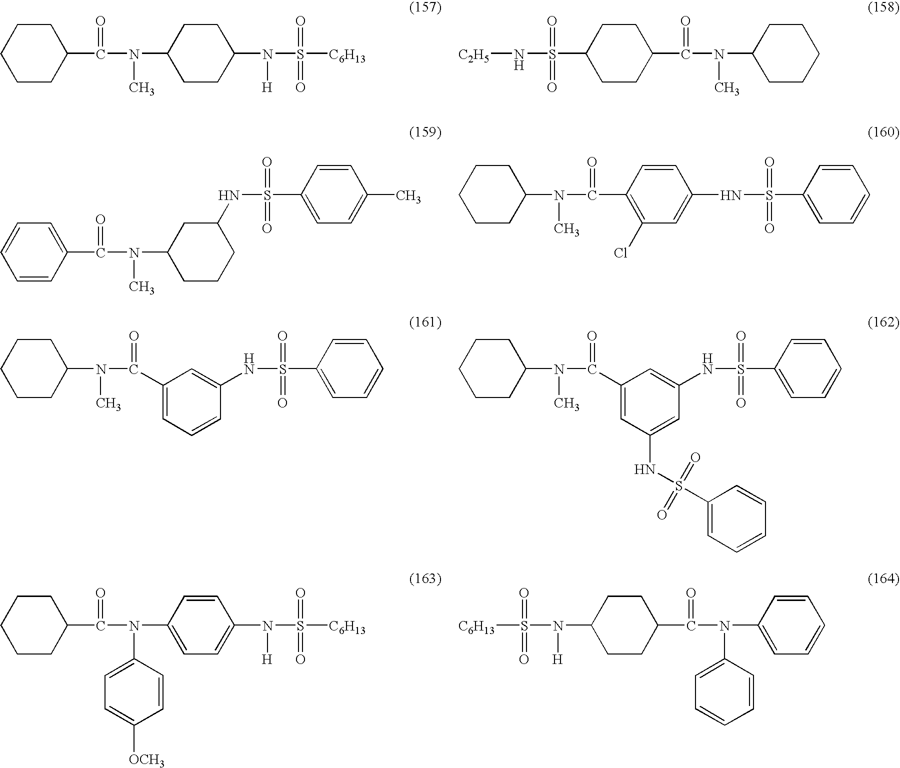

As examples of the Rth-lowering agent, compounds represented by the following formula (2) may be also cited.

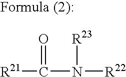

In the formula (2), R²¹ represents an alkyl group or an aryl group, and R²² and R²³ each independently represents a hydrogen atom, an alkyl group or an aryl group. The alkyl group may be either chain type, branched or cyclic. It is preferable that the alkyl group has from 1 to 20 carbon atoms, more preferably from 1 to 15 carbon atoms and especially preferably from 1 to 12 carbon atoms. As a cyclic alkyl group, a cyclohexyl group is particularly preferred. It is preferable that the aryl group has from 6 to 36 carbon atoms, more preferably from 6 to 24 carbon atoms. It is preferable that the sum of the carbon atoms in R²¹ and R²² is 10 or more. These alkyl and aryl groups may have substituents.

The above alkyl and aryl groups may have substituents and preferable examples of the substituents include halogen atoms (for example, chlorine, bromine, fluorine and iodine), alkyl groups, aryl groups, alkoxy groups, aryloxy groups, acyl groups, alkoxycarbonyl groups, aryloxycarbonyl groups, acyloxy groups, sulfonylamino groups, hydroxy group, cyano group, amino group and acylamino groups. Still preferable examples thereof include halogen atoms, alkyl groups, aryl groups, alkoxy groups, aryloxy groups, sulfonylamino groups and acylamino groups. Particularly preferable examples thereof include alkyl groups, aryl groups, sulfonylamino groups and acylamino groups.

Next, preferable examples of the compounds represented by the formula (2) will be presented, though the invention is not restricted to these specific examples.

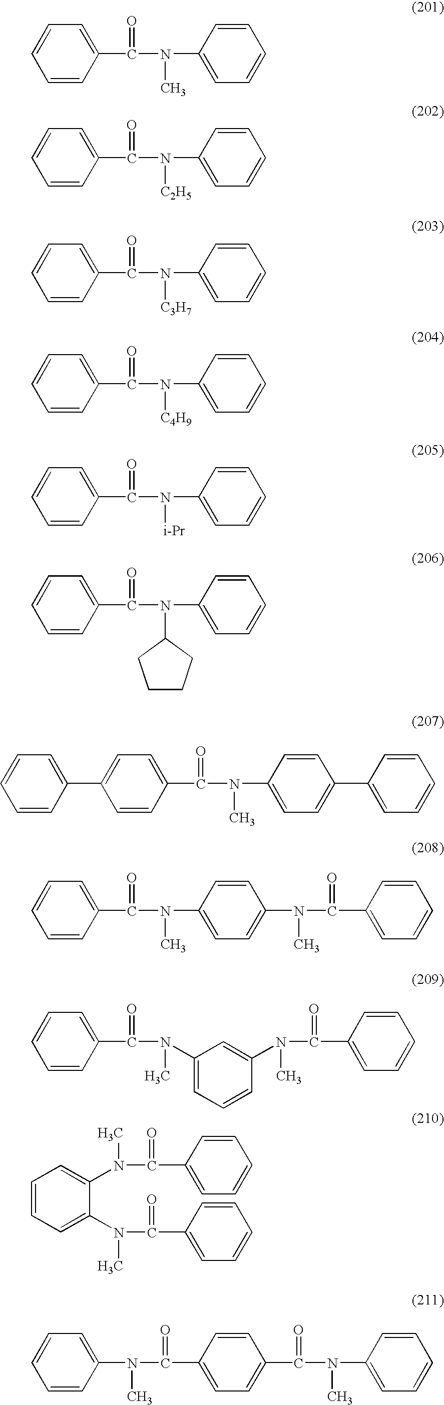

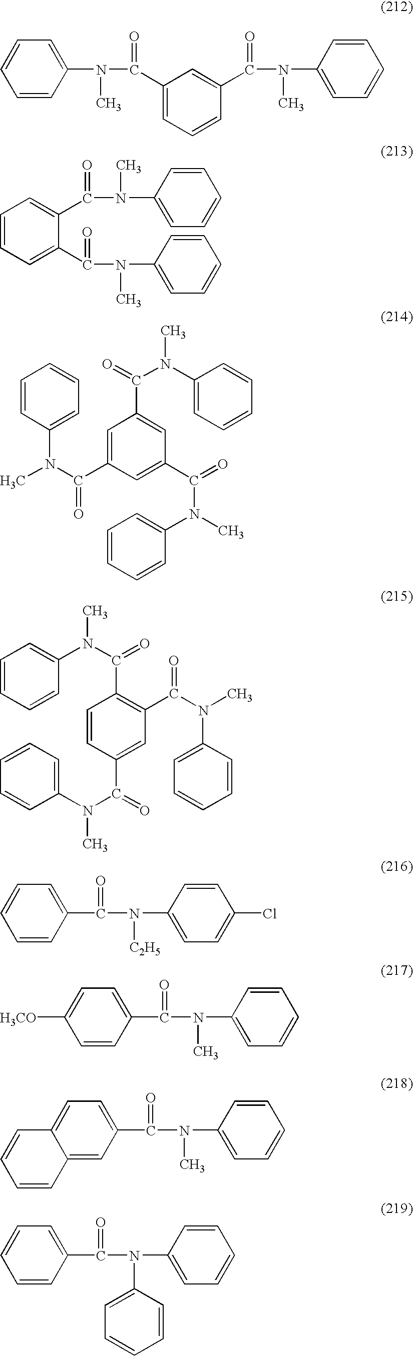

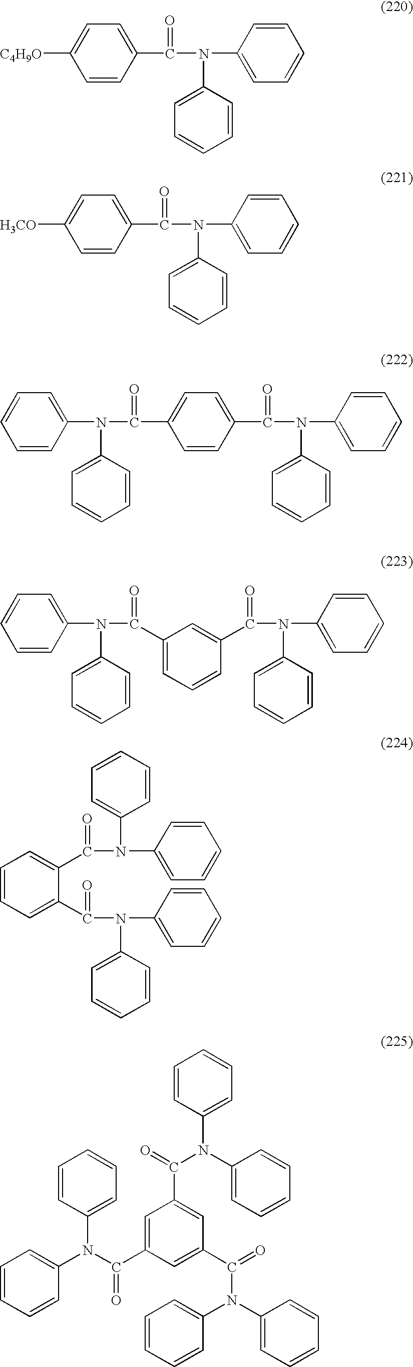

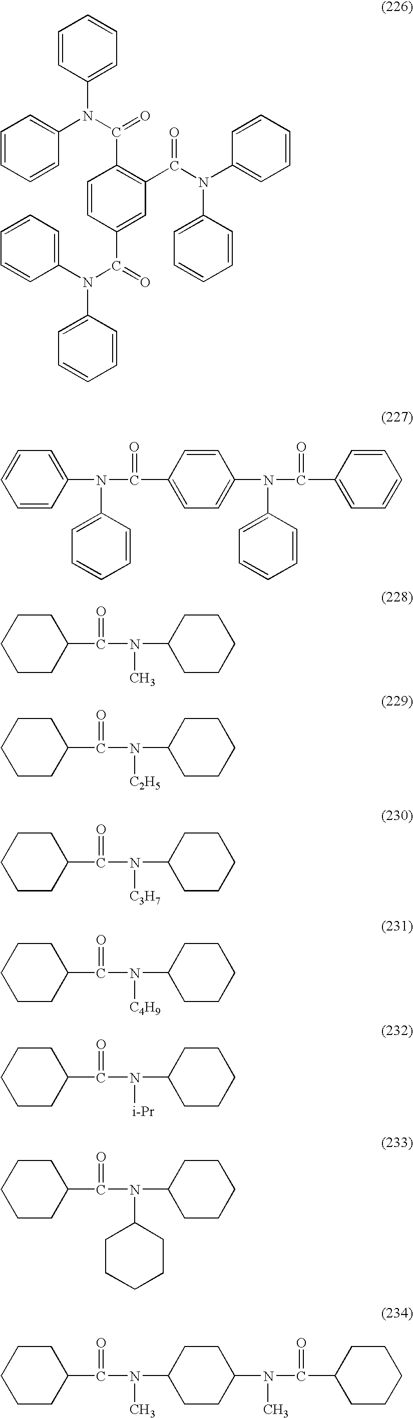

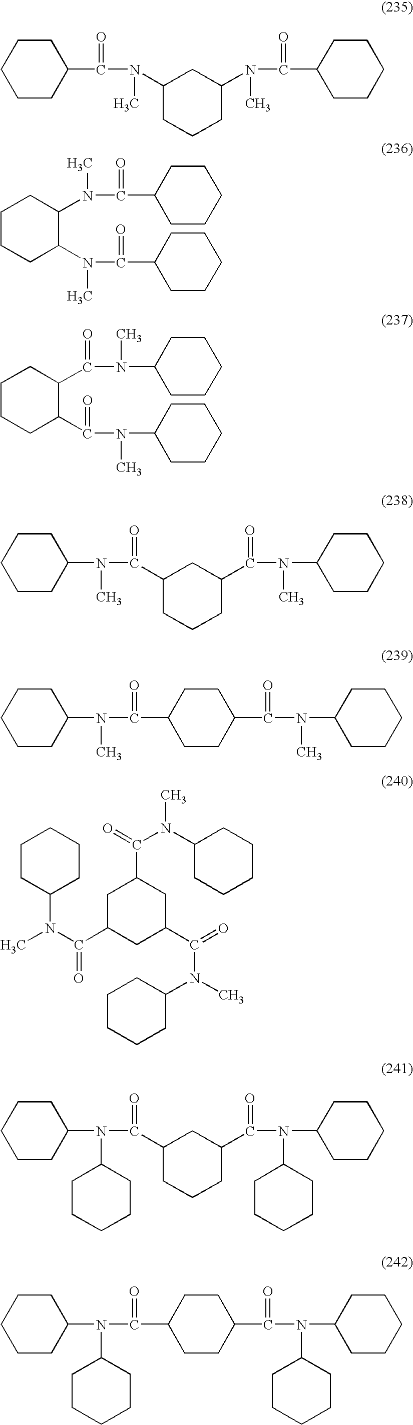

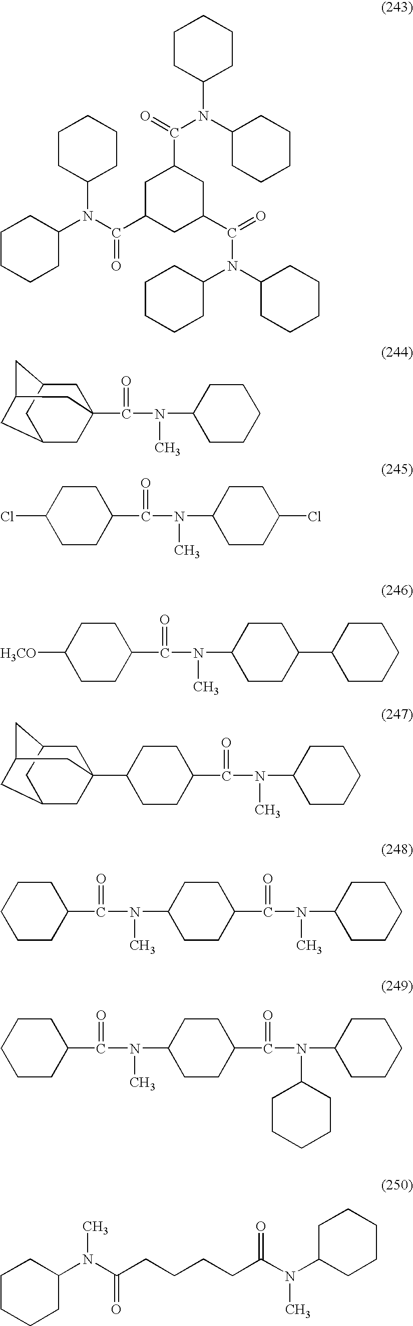

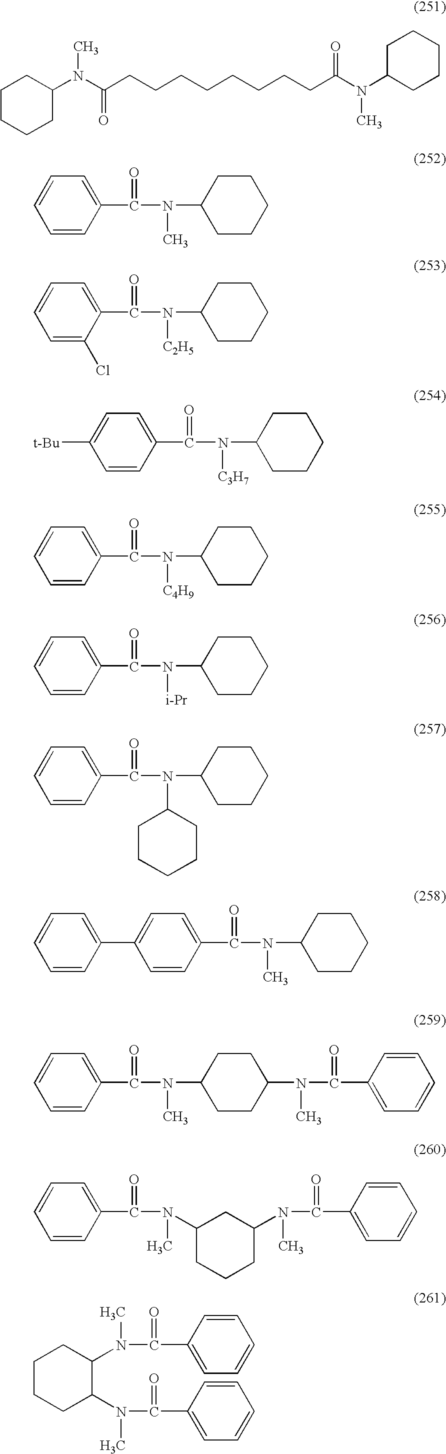

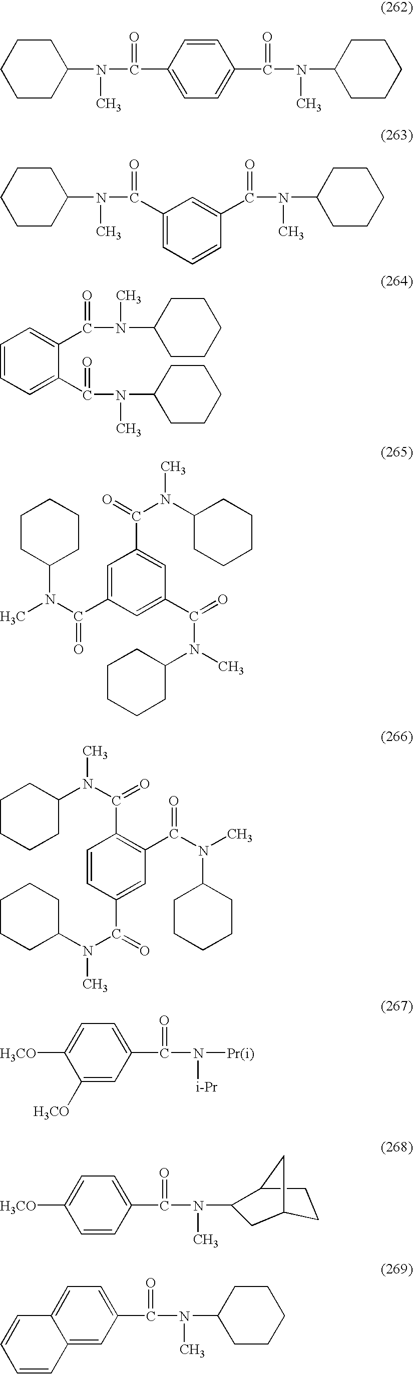

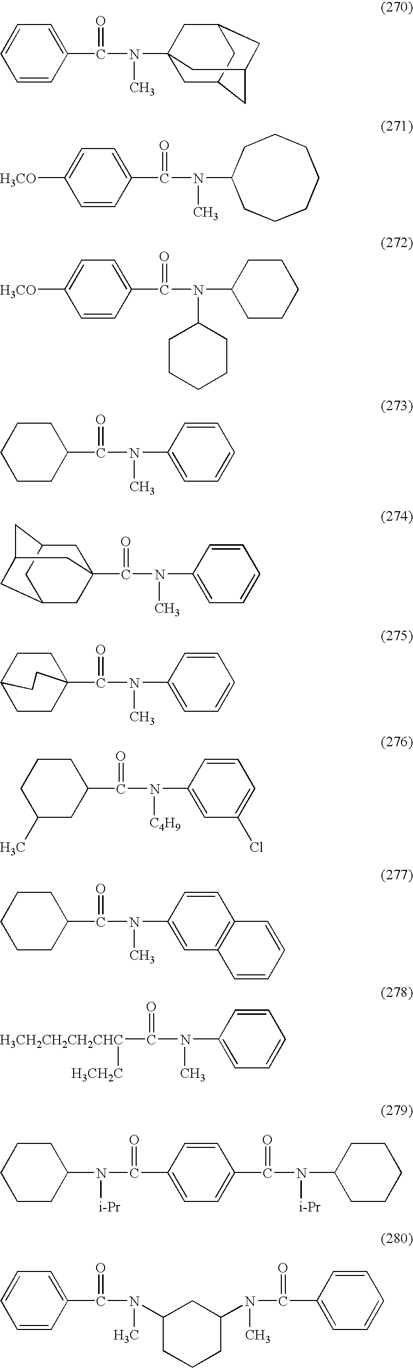

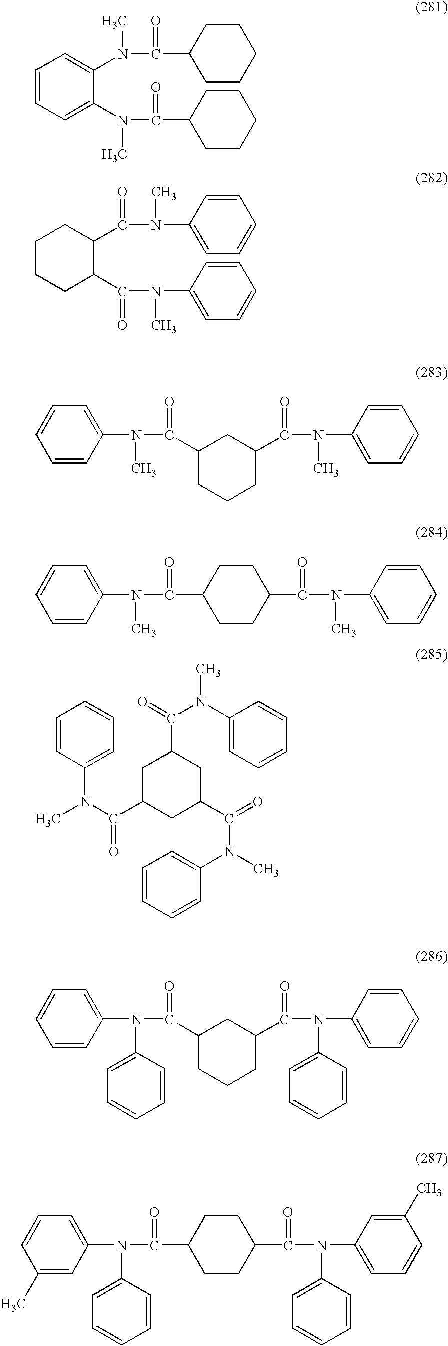

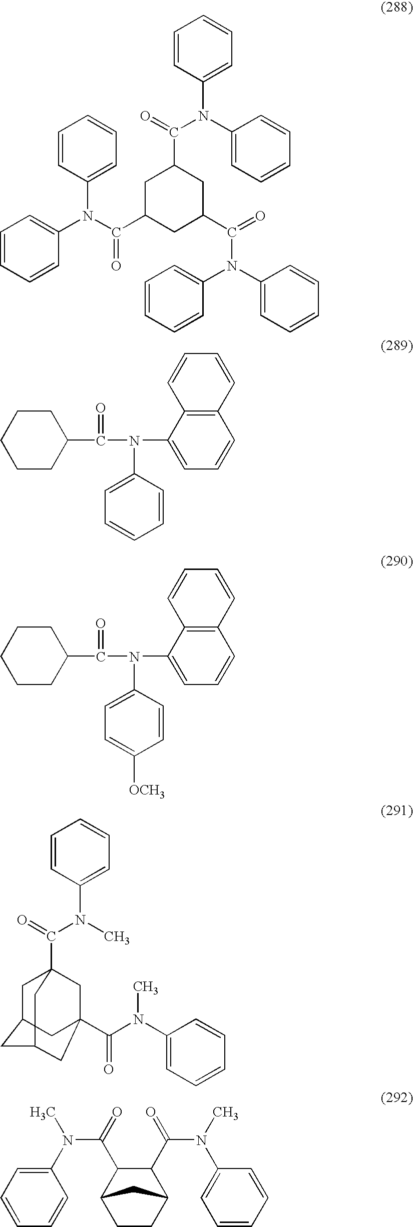

### (Wavelength Dispersion Regulator)

It is preferable that the cellulose acylate film of the invention contains at least one compound capable of lessening |Re₄₀₀−Re₇₀₀| and |Rth₄₀₀−Rth₇₀₀|, i.e., a compound capable of lessening the wavelength dispersion of retardation (hereinafter referred to as a wavelength dispersion regulator) in an amount of from 0.01 to 30% by mass based on the solid content of the polymer material of the cellulose acylate film. Next, the wavelength dispersion regulator will be illustrated.

To improve the wavelength dispersion of Rth of the cellulose acylate film of the invention, it is preferable that the film contains at least one compound lowering the wavelength dispersion of Rth (ΔRth) represented by the following numerical formula (6) (a wavelength dispersion regulator) within a range of fulfilling the following numerical formulae (7) and (8).

ΔRth=|Rth₄₀₀−Rth₇₀₀| Numerical formula (6)

(ΔRth_{B}ΔRth₀)/B<−2.0 Numerical formula (7)

0.01≦B≦30. Numerical formula (8)

Concerning the above numerical formulae (7) and (8), it is still preferable:

(ΔRth_{B}ΔRth₀)/B≦−3.0 Numerical formula (7-2)

0.05≦B≦25. Numerical formula (8-2)

And it is still preferable:

(ΔRth_{B}−ΔRth₀)/B≦−4.0 Numerical formula (7-3)

0.1≦B≦20. Numerical formula (8-3)

In the above formulae, ΔRth_{B} is ΔRth (nm) of a film containing B % by mass of a wavelength dispersion regulator. ΔRth(0) is ΔRth (nm) of a film containing no wavelength dispersion regulator. B is the mass (%) of the wavelength dispersion regulator referring the mass of the polymer employed as the film material as to 100.

### (Method of Adding Wavelength Dispersion Regulator)

As the wavelength dispersion regulator, a single compound may be used. Alternatively, use can be made of a mixture of two or more compounds at an arbitrary ratio. The wavelength dispersion regulator may be added at any step during the production of a dope. It may be added at the final sate of the dope preparation step.

Specific examples of the wavelength dispersion regulator preferably usable in the invention include benzotriazole compounds, benzophenone compounds, cyano-containing compounds, oxobenzophenone compounds, salicylic acid ester compounds, nickel complex salt compounds and so on though the invention is not restricted to these compounds

As the benzotriazole compounds, those represented by the formula (3) are preferably usable as the wavelength dispersion regulator in the invention.

Q³¹-Q³²-OH Formula (3)

In the above formulae, Q³¹ represents a nitrogen-containing aromatic heterocycle, while Q³² represents an aromatic ring.

Q³¹ represents a nitrogen-containing aromatic heterocycle, preferably a 5- to 7-membered nitrogen-containing aromatic heterocycle and more preferably a 5- or 6-membered nitrogen-containing aromatic heterocycle such as imidazole, pyrazole, triazole, tetrazole, thiazole oxazole, selenazole, benzotriazole, benzothiazole, benzoxaxzole, benzoselenazole, thiadiazole, oxadiazole, naphthothiazole, naphtooxazole, azabenzimidazole, purine, pyridine, pyrazine, pyrimidine, pyridazine, triazine, triazaindene, tetrazaindene and so on. More preferably, Q³¹ represents a 5-membered nitrogen-containing aromatic heterocycle such as imidazole, pyrazole, triazole, tetrazole, thiazole, oxazole, benzotriazole, benzothiazole, benzoxazole, thiadiazole or oxadiazole, and benzotriazole is particularly preferable.

The nitrogen-containing aromatic heterocycle represented by Q³¹ may have a substituent and examples of the substituent include the substituent T which will be described hereinafter. In the case of having a plural number of substituents, these substituents may be fused together to form an additional ring.

The aromatic ring represented by Q³² may be either an aromatic hydrocarbon ring or an aromatic heterocycle. It may be a single ring or it may form a fused ring together with another ring.

Preferable examples of the aromatic hydrocarbon ring include monocyclic or bicyclic aromatic hydrocarbon rings having from 6 to 30 carbon atoms (for example, benzene ring, naphthalene ring and so on), more preferably an aromatic hydrocarbon ring having from 6 to 20 carbon atoms and more preferably an aromatic hydrocarbon ring having from 6 to 12 carbon atoms. A benzene ring is the most desirable one.

Preferable examples of the aromatic heterocycle include nitrogen atom-containing or sulfur atom-containing aromatic heterocycles. Specific examples of the heterocycle include thiophene, imidazole, pyrazole, pyridine, pyrazine, pyridazine, triazole, trizine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthridine, phenazine, tetrazole, benzimidazole, benzoxazole, benzthiazole, benzotriazole, tetrazaindene and so on. Preferable examples of the aromatic heterocycles include pyridine, triazine and quinoline.

The aromatic ring represented by Q³² is preferably an aromatic hydrocarbon ring, more preferably a naphthalene ring or a benzene ring and particularly preferably a benzene ring. Q³² may have a substituent and examples of the substituent include the substituent T which will be described hereinafter.

Examples of the substituent T include alkyl groups (preferably having from 1 to 20 carbon atoms, more preferably from 1 to 12 carbon atoms and particularly preferably from 1 to 8 carbon atoms, such as methyl, ethyl, isopropyl, tert-butyl, n-octyl, n-decyl, n-hexadecyl, cyclopropyl, cyclopentyl and cyclohexyl), alkenyl groups (preferably having from 2 to 20 carbon atoms, more preferably from 2 to 12 carbon atoms and particularly preferably from 2 to 8 carbon atoms, such as vinyl, allyl, 2-butenyl and 3-pentenyl), alkynyl groups (preferably having from 2 to 20 carbon atoms, more preferably from 2 to 12 carbon atoms and particularly preferably from 2 to 8 carbon atoms, such as propargyl and 3-pentynyl), aryl groups (preferably having from 6 to 30 carbon atoms, more preferably from 6 to 20 carbon atoms and particularly preferably from 6 to 12 carbon atoms, such as phenyl, p-methylphenyl and naphthyl), substituted or unsubstituted amino groups (preferably having from 0 to 20 carbon atoms, more preferably from 0 to 10 carbon atoms and particularly preferably from 0 to 6 carbon atoms, such as amino, methylamino, dimethylamino, diethylamino and dibenzylamino), alkoxy groups (preferably having from 1 to 20 carbon atoms, more preferably from 1 to 12 carbon atoms and particularly preferably from 1 to 8 carbon atoms, such as methoxy, ethoxy and butoxy), aryloxy groups (preferably having from 6 to 20 carbon atoms, more preferably from 6 to 16 carbon atoms and particularly preferably from 6 to 12 carbon atoms, such as phenyloxy and 2-naphthyloxy), acyl groups (preferably having from 1 to 20 carbon atoms, more preferably from 1 to 16 carbon atoms and particularly preferably from 1 to 12 carbon atoms, such as acetyl, benzoyl, formyl and pivaloyl), alkoxycarbonyl groups (preferably having from 2 to 20 carbon atoms, more preferably from 2 to 16 carbon atoms and particularly preferably from 2 to 12 carbon atoms, such as methoxycarbonyl and ethoxycarbonyl), aryloxycarbonyl groups (preferably having from 7 to 20 carbon atoms, more preferably from 7 to 16 carbon atoms and particularly preferably from 7 to 10 carbon atoms, such as phenyoxycarbonyl), acyloxy groups (preferably having from 2 to 20 carbon atoms, more preferably from 2 to 16 carbon atoms and particularly preferably from 2 to 10 carbon atoms, such as acetoxy and benzoyloxy), acylamino groups (preferably having from 2 to 20 carbon atoms, more preferably from 2 to 16 carbon atoms and particularly preferably from 2 to 10 carbon atoms, such as acetylamino and benzoylamino), alkoxycarbonylamino groups (preferably having from 2 to 20 carbon atoms, more preferably from 2 to 16 carbon atoms and particularly preferably from 2 to 12 carbon atoms, such as methoxycarbonylamino), aryloxycarbonylamino groups (preferably having from 7 to 20 carbon atoms, more preferably from 7 to 16 carbon atoms and particularly preferably from 7 to 12 carbon atoms, such as phenyloxycarbonylamino), sulfonylamino groups (preferably having from 1 to 20 carbon atoms, more preferably from 1 to 16 carbon atoms and particularly preferably from 1 to 12 carbon atoms, such as methanesulfonylamino and benzenesulfonylamino), sulfamoyl groups (preferably having from 0 to 20 carbon atoms, more preferably from 0 to 16 carbon atoms and particularly preferably from 0 to 12 carbon atoms, such as sulfamoyl, methylsulfamoyl, dimethylsulfamoyl and phenylsulfamoyl), carbamoyl groups (preferably having from 1 to 20 carbon atoms, more preferably from 1 to 16 carbon atoms and particularly preferably from 1 to 12 carbon atoms, such as carbamoyl, methylcarbamoyl, diethylcarbamoyl and phenylcarbamoyl), alkylthio groups (preferably having from 1 to 20 carbon atoms, more preferably from 1 to 16 carbon atoms and particularly preferably from 1 to 12 carbon atoms, such as methyltio and ethylthio), arylthio groups (preferably having from 6 to 20 carbon atoms, more preferably from 6 to 16 carbon atoms and particularly preferably from 6 to 12 carbon atoms, such as phenylthio), sulfonyl groups (preferably having from 1 to 20 carbon atoms, more preferably from 1 to 16 carbon atoms and particularly preferably from 1 to 12 carbon atoms, such as mesyl and tosyl), sulfinyl groups (preferably having from 1 to 20 carbon atoms, more preferably from 1 to 16 carbon atoms and particularly preferably from 1 to 12 carbon atoms, such as methanesulfinyl and benzenesulfinyl), ureido groups (preferably having from 1 to 20 carbon atoms, more preferably from 1 to 16 carbon atoms and particularly preferably from 1 to 12 carbon atoms, such as ureido, methylureido and phenylureido), phosphoramido groups (preferably having from 1 to 20 carbon atoms, more preferably from 1 to 16 carbon atoms and particularly preferably from 1 to 12 carbon atoms, such as diethylphosphoramido and phenylphosphoramido), hydroxy group, mercapto group, halogen atoms (for example, fluorine atom, chlorine atom, bromine atom and iodine atom), cyano group, sulfo group, carboxyl group, nitro group, hydroxamate group, sulfino group, hydrazino group, imino group, heterocyclic groups (preferably having from 1 to 30 carbon atoms, more preferably from 1 to 12 carbon atoms, and having a nitrogen atom, an oxygen atom or a sulfur atom as a hetero atom, such as imidazolyl, pyridyl, quinolyl, furyl, piperidyl, morpholino, benzoxazolyl, benzimidazolyl and benzthiazolyl), silyl groups (preferably having from 3 to 40 carbon atoms, more preferably from 3 to 30 carbon atoms and particularly preferably from 3 to 24 carbon atoms, such as tirmethylsilyl and triphenylsilyl) and so on. These substituents may be further substituted. In the case of having two or more substituent, the substituents may be either the same or different. If possible, these substituents may be bonded together to from a ring.

As the compounds represented by the formula (3), compounds represented the following formula (3-1) are preferable.

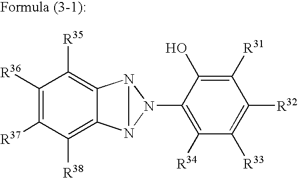

In the above formula, R³¹, R³², R³³, R³⁴, R³⁵, R³⁶, R³⁷ and R³⁸ independently represent each a hydrogen atom or a substituent. As the substituent, the above-described substituents T may be used. These substituents may be further substituted by another substituent and substituents may be fused together to form a cyclic structure.

R³¹ and R³³ preferably represent each a hydrogen atom, an alkyl group, an alkenyl group, an alkynyl group, an aryl group) a substituted or unsubstituted amino group, an alkoxy group, an aryloxy group, a hydroxy group or a halogen atom. It more preferably represents a hydrogen atom, an alkyl group, an aryl group, an aryloxy group or a halogen atom, more preferably a hydrogen atom or an alkyl group having from 1 to 12 carbon atoms and particularly preferably an alkyl group having from 1 to 12 (preferably from 4 to 12) carbon atoms.

R³² and R³⁴ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group, an aryl group, an alkyloxy group, an aryloxy group or a halogen atom, more preferably a hydrogen atom or an alkyl group having from 1 to 12 carbon atoms, particularly preferably a hydrogen atom or a methyl group and most desirably a hydrogen atom.

R³⁵ and R³⁶ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group, an aryl group, an alkyloxy group, an aryloxy group or a halogen atom, more preferably a hydrogen atom or an alkyl group having from 1 to 12 carbon atoms, particularly preferably a hydrogen atom or a methyl group and most desirably a hydrogen atom.

R³⁶ and R³⁷ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group, an aryl group, an alkyloxy group, an aryloxy group or a halogen atom, more preferably a hydrogen atom or a halogen atom and particularly preferably a hydrogen atom or a chlorine atom.

As the compounds represented by the formula (3), compounds represented the following formula (3-2) are still preferable.

### Formula (3-2):

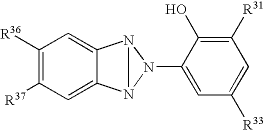

In the above formula, R³¹, R³³, R³⁶ and R³⁷ have the same meanings as defined in the formula (3-1). Preferable ranges thereof are also the same.

Next, preferable examples of the compounds represented by the formula (3) will be presented, though the invention is not restricted to these specific examples.

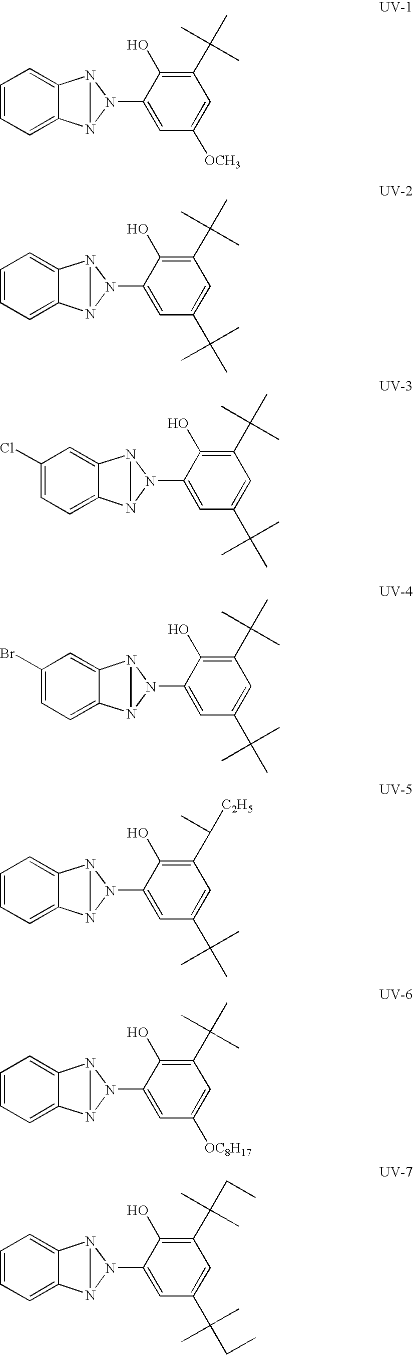

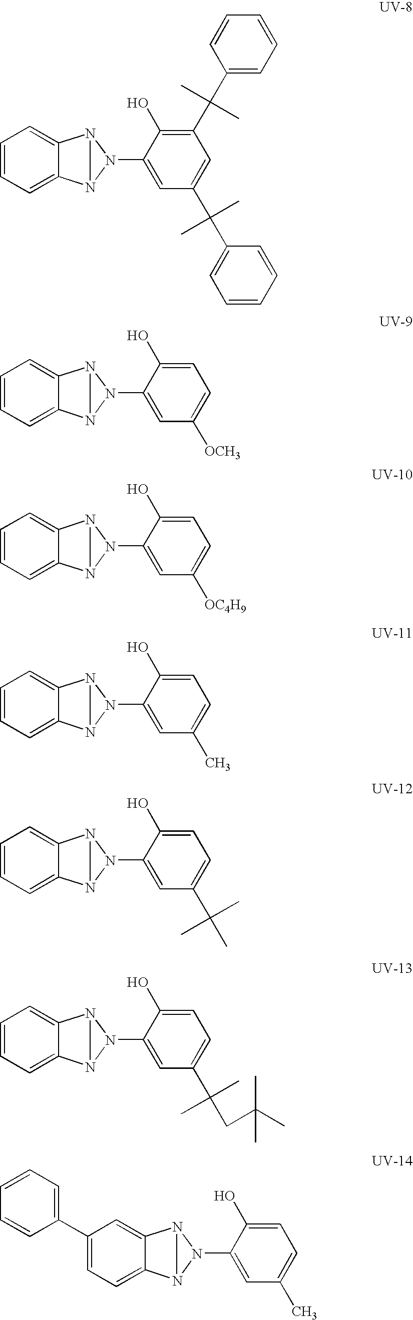

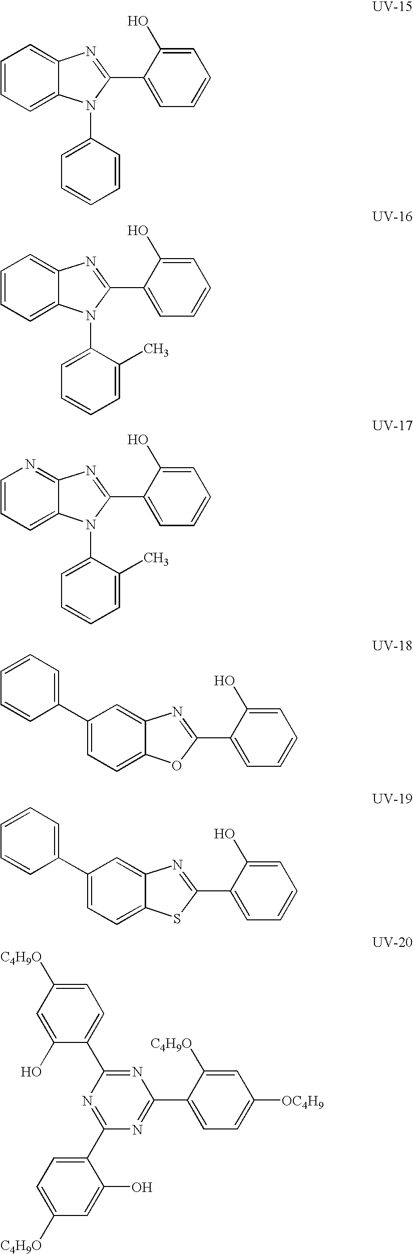

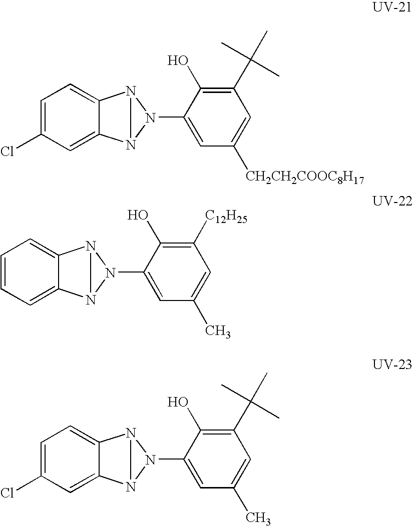

It is confirmed that the cellulose acylate film of the invention produced by using a benzotriazole compound having a molecular weight of 320 or more, from among the benzotriazole compounds presented above, is advantageous from the viewpoint of retention.

As a benzophenone compound which is one of the wavelength dispersion regulators usable in the invention, it is preferable to employ a compound represented by the following formula (4).

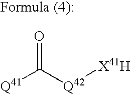

In the above formula, Q⁴¹ and Q⁴² independently represent each an aromatic ring. X⁴¹ represents NR⁴¹ (wherein R⁴¹ represents a hydrogen atom or a substituent), an oxygen atom or a sulfur atom.

The aromatic rings represented by Q⁴¹ and Q⁴² may be either aromatic hydrocarbon rings or aromatic heterocycles. They may be a single ring or foim a flsed ring together with another ring.

Preferable examples of the aromatic hydrocarbon ring represented by Q⁴¹ and Q⁴² include monocyclic or bicyclic aromatic hydrocarbon rings having from 6 to 30 carbon atoms (for example, benzene ring, naphthalene ring and so on), more preferably an aromatic hydrocarbon ring having from 6 to 20 carbon atoms and more preferably an aromatic hydrocarbon ring having from 6 to 12 carbon atoms. A benzene ring is the most desirable one.

Preferable examples of the aromatic heterocycle represented by Q⁴¹ and Q⁴² include aromatic heterocycles containing at least one of oxygen, nitrogen and sulfur atoms. Specific examples of the heterocycle include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthridine, phenazine, tetrazole, benzimidazole, benzoxazole, benzthiazole, benzotriazole, tetrazaindene and so on. Preferable examples of the aromatic heterocycles include pyridine, triazine and quinoline.

The aromatic rings represented by Q⁴¹ and Q⁴² are each preferably an aromatic hydrocarbon ring, more preferably an aromatic hydrocarbon ring having from 6 to 10 carbon atoms and more preferably a substituted or unsubstituted benzene ring.

Q⁴¹ and Q⁴² may have a substituent and examples of the substituent include the substituent T as described above, provided that such a substituent never contains carboxylic acid, sulfonic acid or a quaternary ammonium salt. If possible, substituents may be bonded together to form a cyclic structure.

X⁴¹ represents NR⁴¹ (wherein R⁴¹ represents a hydrogen atom or a substituent which include the substituent T as described above), an oxygen atom or a sulfur atom. It is preferable that X⁴¹ is NR⁴² (wherein R⁴² preferably represents an acyl group or a sulfonyl group and such a substituent may further have a substituent) or an oxygen atom. An oxygen atom is particularly preferred.

As the compounds represented by the formula (4), compounds represented the following formula (4-1) are preferable.

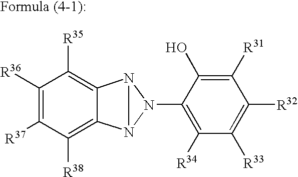

In the above formula, R⁴¹¹, R⁴¹², R⁴¹³, R⁴¹⁴, R⁴¹⁵, R⁴¹⁶, R⁴¹⁷, R⁴¹⁸ and R⁴¹⁹ independently represent each a hydrogen atom or a substituent. As the substituent, the above-described substituents T may be used. These substituents may be further substituted by another substituent and substituents may be fused together to form a cyclic structure.

R⁴¹¹, R⁴¹³, R⁴¹⁴, R⁴¹⁵, R⁴¹⁶, R⁴¹⁸ and R⁴¹⁹ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group, an aryl group, an alkyloxy group, an aryloxy group or a halogen atom, more preferably a hydrogen atom or an alkyl group having from 1 to 12 carbon atoms and particularly preferably a hydrogen atom or a methyl group. A hydrogen atom is the most desirable one.

R⁴¹² preferably represents a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group having from 1 to 20 carbon atoms, an amino group having from 0 to 20 carbon atoms, an alkoxy group having from 1 to 12 carbon atoms, an aryloxy group having from 6 to 12 carbon atoms or a hydroxy group, more preferably an alkoxy group having from 1 to 20 carbon atoms and particularly preferably an alkoxy group having from 1 to 12 carbon atoms.

R⁴¹⁷ preferably represents a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group having from 1 to 20 carbon atoms, an amino group having from 0 to 20 carbon atoms, an alkoxy group having front 1 to 12 carbon atoms, an aryloxy group having from 6 to 12 carbon atoms or a hydroxy group, more preferably a hydrogen atom or an alkyl group having from 1 to 20 carbon atoms (preferably from 1 to 12 carbon atoms, more preferably from 1 to 8 carbon atoms, and more preferably a methyl group). A methyl group or a hydrogen atom is particularly preferred.

As the compounds represented by the formula (4), compounds represented the following formula (4-2) are still preferable.

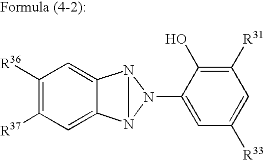

In the above formula, R⁴²⁰ represents a hydrogen atom, a substituted or unsubstituted alkyl group, a substituted or unsubstituted alkenyl group, a substituted or unsubstituted alkynyl group or a substituted or unsubstituted aryl group. As the substituent, the above-described substituents T may be used. R⁴²⁰ preferably represents a substituted or unsubstituted alkyl group, more preferably a substituted or unsubstituted alkyl group, more preferably a substituted or unsubstituted alkyl group having from 5 to 20 carbon atoms, more preferably a substituted or unsubstituted alkyl group having from 5 to 12 carbon atoms (for example, n-hexyl, 2-ethylhexyl, n-octyl, n-decyl, n-dodecyl or benzyl group), and particularly preferably a substituted or unsubstituted alkyl group having from 6 to 12 carbon atoms (for example, 2-ethylhexyl, n-octyl, n-decyl, n-dodecyl or benzyl group).

The compounds represented by the formula (4) can be synthesized by a publicly known method reported in JP-A-11-12219.

Next, specific examples of the compounds represented by the formula (4) will be presented, though the invention is not restricted to these specific examples.

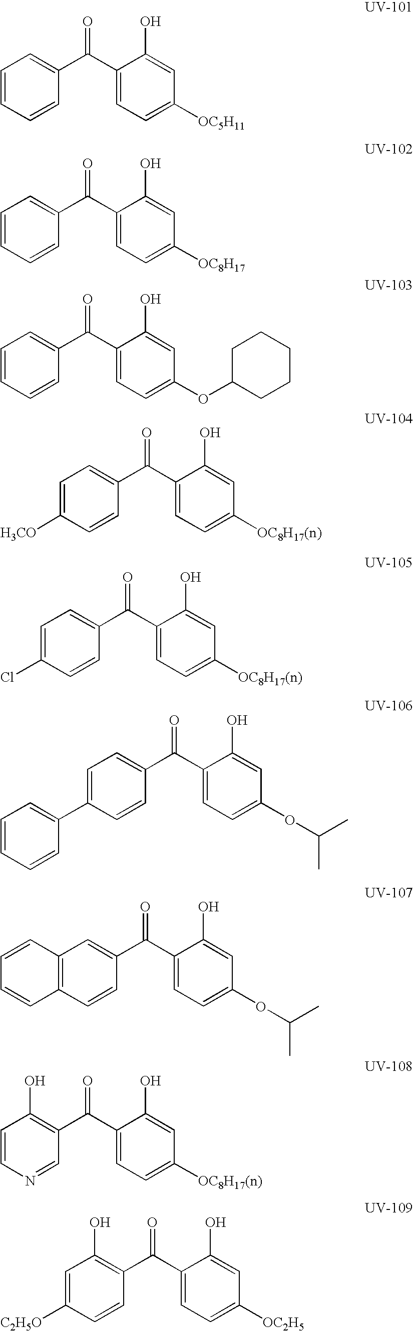

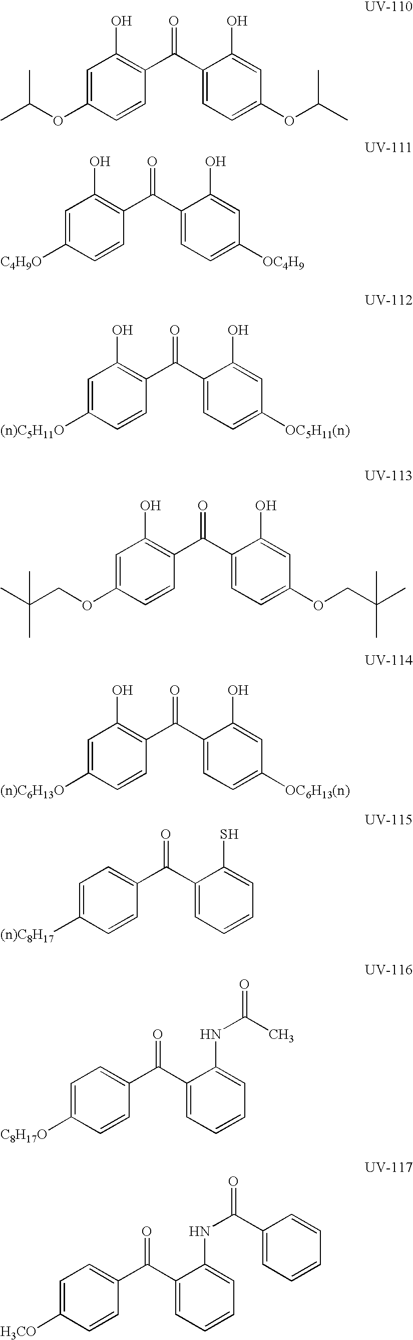

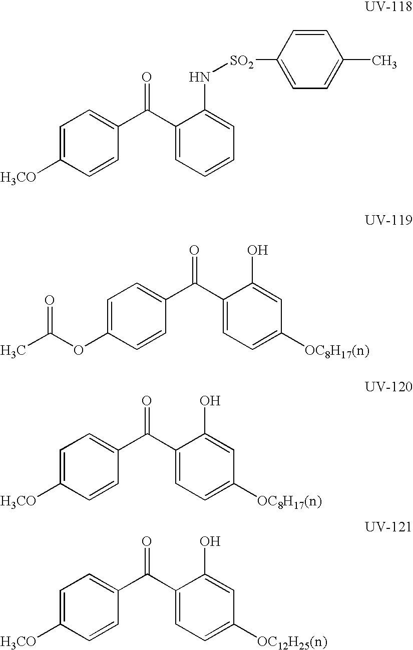

In the invention, use can be also made of a cyano group-containing compound as the wavelength dispersion regulator. As such a cyano group-containing compound, compounds represented by the formula (5) are preferred.

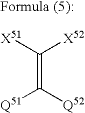

In the above formula, Q⁵¹ and Q⁵² independently represent each an aromatic ring. X¹ and X² represent each a hydrogen atom or a substituent, provided that at least one of them represents a cyano group, a carbonyl group, a sulfonyl group or an aromatic heterocycle. The aromatic rings represented by Q⁵¹ and Q⁵² may be either aromatic hydrocarbon rings or aromatic heterocycles. They may be a single ring or form a fused ring together with another ring.

Preferable examples of the aromatic hydrocarbon ring include monocyclic or bicyclic aromatic hydrocarbon rings having from 6 to 30 carbon atoms (for example, benzene ring, naphthalene ring and so on), more preferably an aromatic hydrocarbon ring having from 6 to 20 carbon atoms and more preferably an aromatic hydrocarbon ring having from 6 to 12 carbon atoms. A benzene ring is the most desirable one.

Preferable examples of the aromatic heterocycle include aromatic heterocycles containing a nitrogen atom or a sulfur atom. Specific examples of the heterocycle include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthridine, pbenazine, tetrazole, benzimidazole, benzoxazole, benzthiazole, benzotriazole, tetrazaindene and so on. Preferable examples of the aromatic heterocycles include pyridine, triazine and quinoline.

The aromatic rings represented by Q⁵¹ and Q⁵² are each preferably an aromatic hydrocarbon ring, and more preferably a benzene ring. Q⁵¹ and Q⁵² may have a substituent and preferable examples of the substituent include the substituent T as described above.

X⁵¹ and X⁵² represent each a hydrogen atom or a substituent, provided that at least one of them represents a cyano group, a carbonyl group, a sulfonyl group or an aromatic heterocycle. As the substituents represented by X⁵¹ and X⁵² may be the substituents T as described above. The substituents represented by X⁵¹ and X⁵² may be substituted by another substituent. X⁵¹ and X⁵² may be fused to form a cyclic structure.

Preferable examples of X⁵¹ and X⁵² include hydrogen atom, alkyl groups, aryl groups, cyano group, nitro group, carbonyl group, sulfonyl groups and aromatic heterocycles, more preferably cyano group, carbonyl group, sulfonyl groups and aromatic heterocycles, more preferably cyano group and carbonyl group, and particularly preferably cyano group and alkoxycarbonyl groups (—C(═O)OR⁵¹ wherein R⁵¹ represents an alkyl group having from 1 to 20 carbon atoms, an aryl group having from 6 to 12 carbon atoms or a combination thereof).

As the compounds represented by the formula (5), compounds represented the following formula (5-1) are preferable.

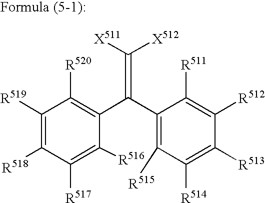

In the above formula, R⁵¹¹, R⁵¹², R⁵¹³, R⁵¹⁴, R⁵¹⁵, R⁵¹⁶, R⁵¹⁷, R⁵¹⁸ R⁵¹⁹ and R⁵²⁰ independently represent each a hydrogen atom or a substituent. As the substituents, the substituent T as described above may be used. These substituents may be further substituted by another substituent and substituents may be fused together to form a cyclic structure. X⁵¹¹ and X⁵¹² respectively have the same meanings as X⁵¹ and X⁵² in the formula (5).

R⁵¹¹, R⁵¹², R⁵¹⁴, R⁵¹⁵, R⁵¹⁶, R⁵¹⁷, R⁵¹⁹ and R⁵²⁰ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group, an aryl group, an alkyloxy group, an aryloxy group or a halogen atom, more preferably a hydrogen atom or an alkyl group having from 1 to 12 carbon atoms and particularly preferably a hydrogen atom or a methyl group. A hydrogen atom is the most desirable one.

R⁵¹³ and R⁵¹⁸ preferably represent each a hydrogen atom, an alkyl group, an alkenyl group, an alkynyl group, an aryl group, a substituted or unsubstituted amino group, an alkoxy group, an aryloxy group, a hydroxy group or a halogen atom. It more preferably represents a hydrogen atom, an alkyl group having from 1 to 20 carbon atoms, an amino group having from 0 to 20 carbon atoms, an alkoxy group having from 1 to 12 carbon atoms, an aryloxy group having from 6 to 12 carbon atoms or a hydroxy group, more preferably a hydrogen atom, an alkyl group having form 1 to 12 carbon atoms or an alkoxy group having from 1 to 12 carbon atoms, and particularly preferably a hydrogen atom

As the compounds represented by the formula (5), compounds represented the following formula (5-2) are still preferable.

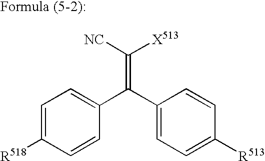

In the above formula, R⁵¹³ and R⁵¹⁸ respectively have the same meanings as those in the formula (5-1) and the preferable ranges thereof are also the same. X⁵¹³ represents a hydrogen atom or a substituent. As the substituent, the substituent T as described above may be used. If possible, it may be further substituted by another substituents.

X⁵¹³ represents a hydrogen atom or a substituent and the above-described substituent T may be used as the substituent. If possible, it may be further substituted by another substituent. X⁵¹³ preferably represents a hydrogen atom, an alkyl group, an aryl group, a cyano group, a nitro group, a carbonyl group, a sulfonyl group or an aromatic heterocycle, more preferably a cyano group or a carbonyl group, and particularly preferably a cyano group or an alkoxycarbonyl group (—C(═O)CR⁵² wherein R⁵² represents an alkyl group having from 1 to 20 carbon atoms, an aryl group having from 6 to 12 carbon atoms or a combination thereof).

As the compounds represented by the formula (5), compounds represented the following formula (5-3) are still preferable.

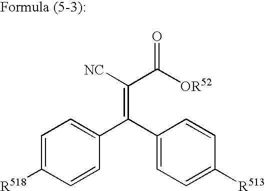

In the above formula, R⁵¹³ and R⁵¹⁸ respectively have the same meanings as those in the formula (5-1) and the preferable ranges thereof are also the same. R⁵² represents an alkyl group having from 1 to 20 carbon atoms. In the case where R⁵¹³ and R⁵¹⁸ are both hydrogen atoms, R⁵² preferably represents an alkyl group having from 2 to 12 carbon atoms, more preferably an alkyl group having from 4 to 12 carbon atoms, more preferably an alkyl group having from 6 to 12 carbon atoms and particularly preferably an n-octyl group, a tert-octyl group, a 2-ethylhexyl group, an n-decyl group or an n-dodecyl group. A 2-ethylhexyl group is the most desirable.

In the case where R⁵¹³ and R⁵¹⁸ are both not hydrogen atoms, R⁵² preferably represents an alkyl group having not more than 20 carbon atoms and making the molecular weight of the compound of the formula (5-3) 300 or more.

In the invention, the compounds represented by the formula (5) can be synthesized by a method described in J. Am. Chem. Soc., vol. 63, p. 3452 (1941).

Next, specific examples of the compounds represented by the formula (5) will be presented, though the invention is not restricted to these specific examples.

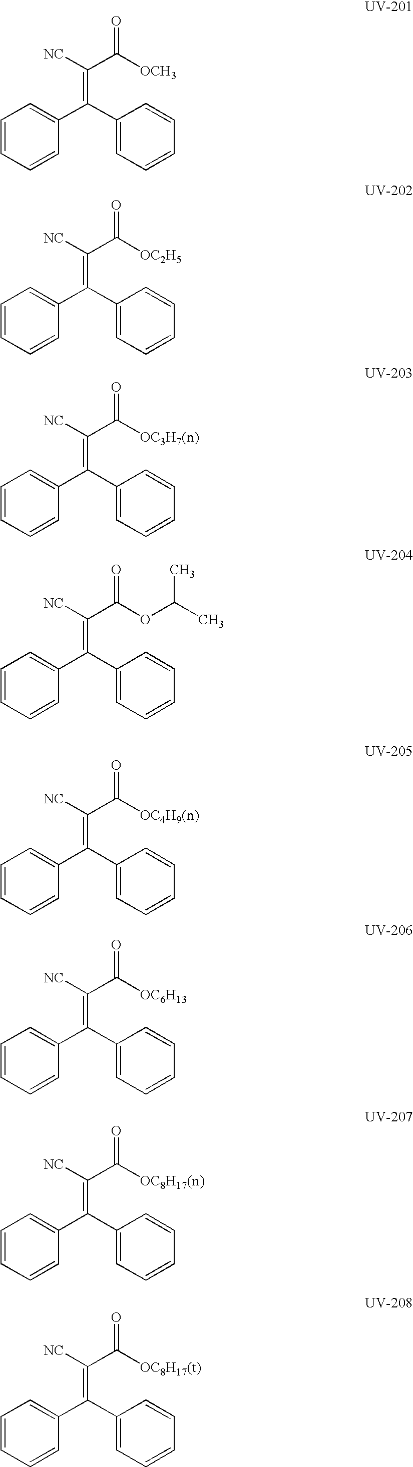

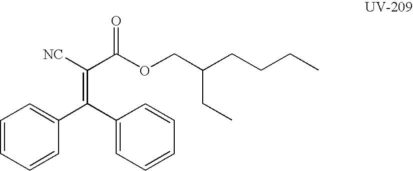

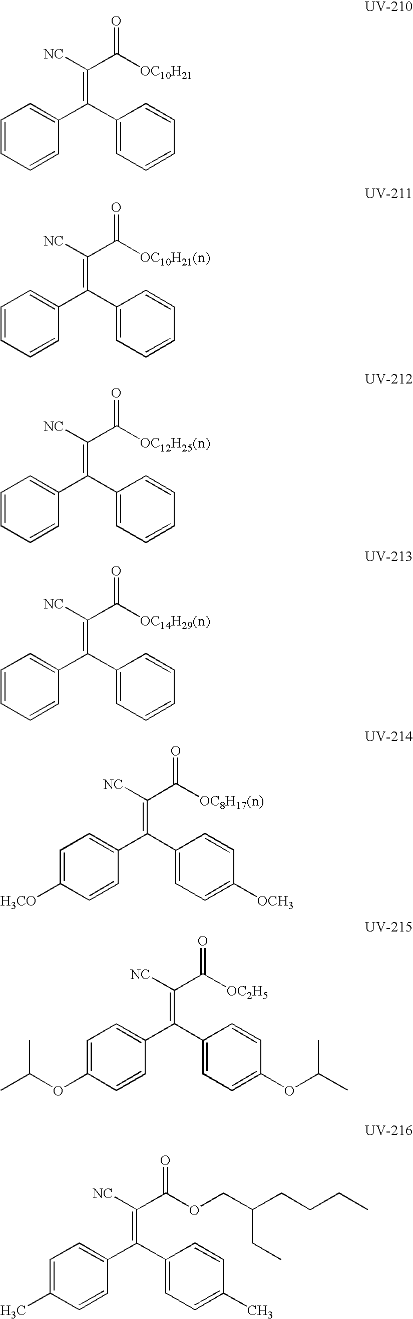

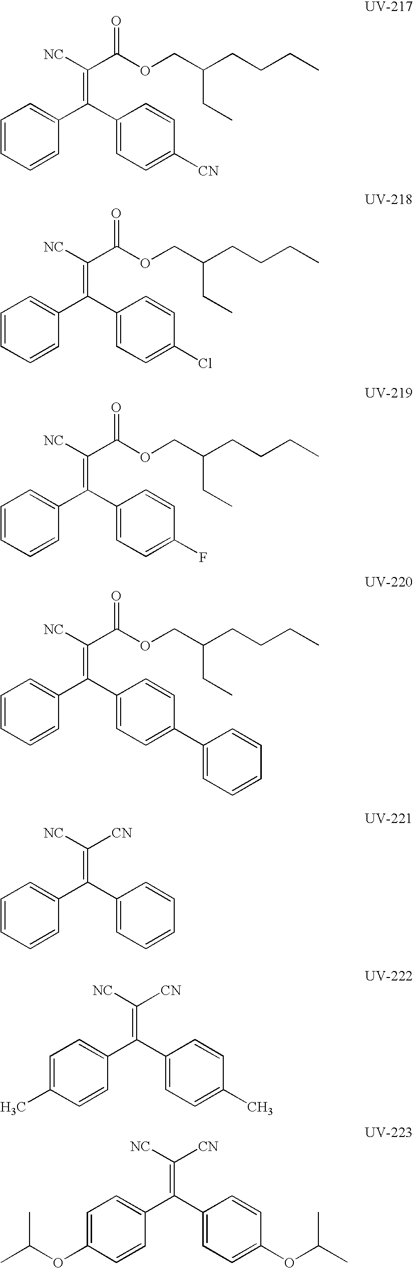

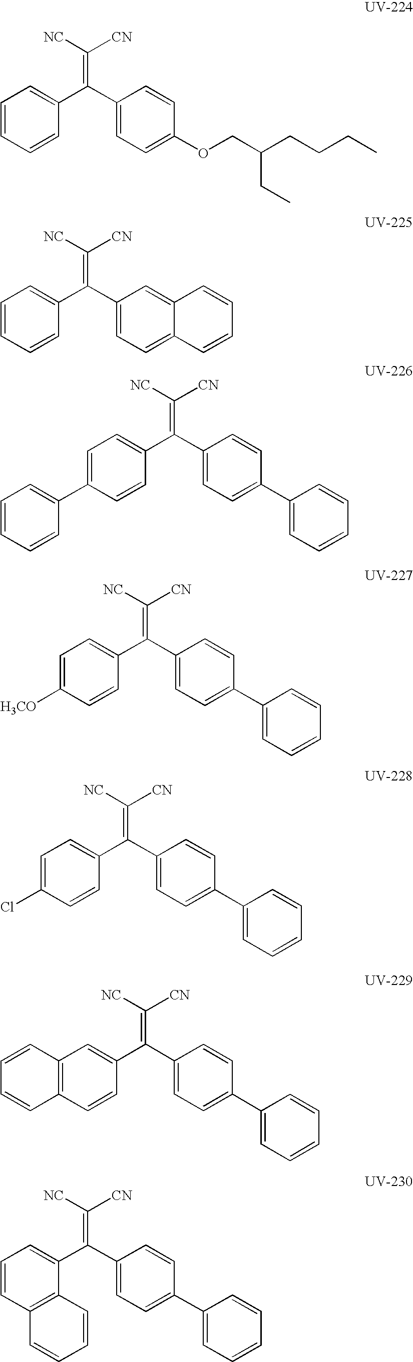

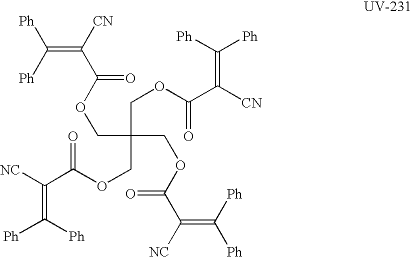

In the cellulose acylate film according to the invention, it is desirable that the spectral transmittance at the wavelength of 380 nm is 45% or more but not more than 95% and the spectral transmittance at the wavelength of 350 nm is 10% or less. The spectral transmittance is determined in practice by measuring the transmittance at 300 to 450 nm in wavelength of a sample (13 mm×40 mm) at 25° C. and 60% RH by using a spectrophotometer (U-3210, manufactured by HTACHI, Ltd.). Tilt width is determined as (wavelength at 72%−wavelength at 5%). Limiting wavelength is represented by (tilt width/2)+wavelength at 5%. Absorption end is expressed in the wavelength at the transmittance of 0.4%. Thus, the transmittances at 380 nm and 350 nm are evaluated.

### (Evaluation of Physical Properties of Cellulose Acylate Film)

### (Optical Performance)

(Change in Optical Performance of Film after High-Humidity Treatment)

It is desirable that the film having been treated at 60° C. and 90% RH for 240 hours shows changes in Re and Rth of not more than 15 nm, more preferably not more than 12 nm and more preferably not more than 10 nm.

(Change in Optical Performance of Film after High-Temperature Treatment)

Also, it is desirable that the film having been treated at 80° C. for 240 hours shows changes in Re and Rth of not more than 15 nm, more preferably not more than 12 nm and more preferably not more than 10 nm.

It is desirable that the thickness of the cellulose acylate film of the invention is from 10 to 120 μm, more preferably from 20 to 100 μm and more preferably from 30 to 90 μm.

(Retardation Change Before and after Stretching Film)

It is preferable that the in-plane retardations of the cellulose acylate film of the invention before and after stretching fulfills the following numerical formula (5).

|Re(n)−Re(0)|/n≦1.0. Numerical formula (5)

In the above formula, Re(n) means the in-plane retardation (nm) of the film having been stretched by n (%), while Re(0) means the in-plane retardation (nm) of the unstretched film.

The above-described evaluation was conducted by preparing a sample (100 mm×100 mm) and stretching it in the machine direction (MD) or in the transverse direction (TD) with the use of a fixed uniaxial stretching machine at a temperature of 140° C. The in-plane retardation Re of each sample is measured before and after the stretching with the use of an automatic birefringence analyzer “KOBRA-21ADI”.

### <Usage of Cellulose Acylate Film>

### (Optically Compensatory Film)

The cellulose acylate film of the invention is usable for various purposes. It is particularly effective to employ the cellulose acylate film of the invention as an optically compensatory film in a liquid crystal display. An optically compensatory film means an optical material which is usually employed in liquid crystal displays to compensate for phase contrast. Namely, it has the same meaning as a phase contrast plate, an optically compensatory sheet, etc. Because of having birefringent properties, an optically compensatory film is employed in order to relieve coloration in a display screen of a liquid crystal display or improve viewing angle characteristics.

It is preferable that the cellulose acylate film of the invention has small optical anisotropy (i.e., 0≦Re≦10 and |Rth|≦25 concerning Re and Rth) and small wavelength dispersion (i.e., |Re₍₄₀₀)−Re₍₇₀₀)|≦10 and |Rth₍₄₀₀₎−Rth₍₇₀₀₎|≦35). When it is used together with an optically anisotropic layer having birefringence, therefore, the optical performance of the optically anisotropic layer can be exclusively achieved without showing any undesired anisotropy. In the case of using the cellulose acylate film of the invention as an optically compensatory film in a liquid crystal display, it is therefore favorable that the optically anisotropic layer used together has Re₆₃₀ of from 0 to 200 nm and |Rth₆₃₀| of form 0 to 400 nm. Any optically anisotropic layer may be used so long as its Re₆₃₀ and Rth₆₃₀ fall within the respective ranges as defined above.

In the liquid crystal display having the cellulose acylate film of the invention, any optically anisotropic layer required in the optically compensatory film can be employed without particularly restricted by the optical performance of the liquid crystal cell or the driving system. The optically anisotropic layer employed together may be made of either a composition containing a liquid crystal compound or a birefringent polymer film. It is also possible to combinedly use these optically anisotropic layers.

### (Optically Anisotropic Layer Containing Liquid Crystal Compound)

In the case of using an optically anisotropic layer containing a liquid compound as the optically anisotropic layer, a discotic liquid crystal compound or a rod-shaped liquid crystal compound is preferred.

### (Discotic Liquid Crystal Compound)

Examples of the discotic liquid crystal compound usable in the invention include compounds described in various documents [C. Destrade et al., Mol. Crysr. Liq. Cryst., vol. 71, p. 111 (1981); ed. by Nihon Kagalcu-kai, Kikan Kagaku Sosetsu, No. 22, Ekisho no Kagaku, chap, 5, chap. 10, par. 2 (1994); B. Kohne et al., Angew. Chem. Soc. Chem. Comm., page 1794 (1985); and J. Zhang et al., J. Am. Chem. Soc., vol. 116, page 2655 (1994)).

In the optically anisotropic layer, it is preferable that the discotic liquid crystal molecules have been fixed in the orientated state. It is most desirable that these molecules have been fixed via a polymerization reaction. Polymerization of discotic liquid crystal molecules is reported in JP-A-8-27284. To fix discotic liquid crystal molecules by polymerization, it is necessary to attach a polymerizable group as a substituent to the disc core of a discotic liquid molecule. When such a polymerizable group is attached directly to the disc core, however, the fixed state can be hardly maintained during the polymerization. Therefore, a linking group is introduced between the disc core and the polymerizable group. Such discotic liquid crystal molecules having polymerizable group are disclosed in JP-2001-4387.

### (Rod-Shaped Liquid Crystal Compound)

Examples of the rod-shaped liquid crystal compound usable in the invention include azomethines, azoxys, cyanobiphenyls, cyanophenyl esters, benzoic acid esters, cyclohexanecarboxlic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. In addition to these low-molecular weight liquid crystal compounds, use can be also made of high-molecular weight liquid crystal compounds.

In the optically anisotropic layer, it is preferable that rod-shaped liquid crystal molecules are fixed in the orientated state, most desirably having been fixed via a polymerization reaction. Examples of the polymerizable rod-shaped liquid crystal compound usable in the invention include compounds described in Makromol. Chem., vol. 190, p. 255 (1989), Advanced Materials, vol. 5, p. 107 (1993), U.S. Pat. No. 4,683,327, U.S. Pat. No. 5,622,648, U.S. Pat. No. 5,770,107, WO 95/22586, WO 95/24455, WO 97/00600, WO 98/23580, WO 98/52905, JP-A-1-272551, JP-A-6-16616, JP-A-7-110469, JP-A-11-80081 and JP-A-2001-328973.

### (Optically Anisotropic Layer Made of Polymer Film)

As described above, the optically anisotropic layer in the invention may be made of a polymer film. In such a case, the polymer film comprises a polymer capable of exhibiting optical anisotropy. Examples of such a polymer include polyolefins (for example, polyethylene, polypropylene and polynorbonene polymers), polycarbonate, polyallylate, polysulfone, polyvinyl alcohol, polymethacrylic acid esters, polyacrylic acid esters, cellulose esters (for example, cellulose triacetate and cellulose diacetate), and so on. It is also possible to use a copolymer of these polymers or a polymer mixture.

It is preferable that the optical anisotropy of the polymer film is achieved by stretching the polymer film. Uniaxial or biaxial stretching is preferred. More specifically speaking, it is preferable to employ longitudinal uniaxial stretching with the use of a difference in circumferential speed between two or more rolls, tenter stretching in the width direction while clipping the polymer film at both sides, or biaxial stretching by combining the same. It is also possible that two or more polymer films are stacked so that the optical properties of the composite films fulfill the above requirements as a whole. To minimize irregularities in birefringence, it is preferable to produce the polymer film by the solvent cast method. The thickness of the polymer film preferably ranges from 20 to 500 μm, most desirably from 40 to 100 μm.

Alternatively, use can be preferably made of a film-forming method which comprises using at least one polymer material selected from the group consisting of polyamide, polyimide, polyester, polyether ketone, polyamidimde, polyesterimide and polyaryl-ether ketone as a material for forming the optically anisotropic layer, coating a substrate with a solution of the polymer material dissolved in a solvent and drying the solvent to give a film. In this case, use may be preferably made of a technique of stretching the polymer film with the substrate to develop optical anisotropy, thereby using as an optically anisotropic layer. The cellulose acylate film of the invention can be preferably employed as the substrate in the above case. It is also preferable that such a polymer film is formed on another substrate and then, after stripping the polymer film from the substrate, laminating it on the cellulose acylate film of the invention and using it as an optically anisotropic layer. According to this method, the polymer film thickness can be reduced. Namely, the polymer film thickness is preferably 50 μm or less, more preferably from 1 to 20 μm.

### (Polarizing Plate)

Next, the usage of the cellulose acylate film of the invention will be described.

The cellulose acylate film of the invention is particularly useful as a protective film for a polarizing plate. In the case of using the cellulose acylate film of the invention as a protective film for a polarizing plate, the polarizing plate may be constructed by a usually employed method without specific restriction, A common method comprises treating the obtained cellulose acylate film with an alkali and then laminating on both faces of a polarizer, which has been constricted by dipping a polyvinyl alcohol film in an iodine solution and stretched, by using a completely saponified aqueous polyvinyl alcohol solution. As an alternative for the alkali treatment, use may be made of a treatment for facilitating adhesion as reported in JP-A-6-94915 or JP-A-6-118232.

Examples of the adhesive to be used for laminating the treated face of the protective film on the polarizer include polyvinyl alcohol-based adhesives such as polyvinyl alcohol and polyvinyl butyral, vinyl-based latexes such as butyl acrylate and so on.

### (Evaluation of Adhesiveness Between Protective Film and Polarizer)

In stacking the treated face of a protective film on a polarizer, a sufficient adhesiveness is required. The adhesiveness of the cellulose acylate film of the invention is tested by laminating on the polarizer, sufficiently drying adhesive components and then repeatedly peeling off the protective film 50 times. Then, the adhesiveness is evaluated in the following three grades: (A) no delamination found after peeling off 50 times; (B) delamination found after peeling off from 30 to 50 times; and (C) delamination found after peeling off less than 30 times.

The polarizing plate is composed of the polarizer and the protective films protecting both faces thereof. It further has a protect film on one face of the polarizing plate and a separate film on the opposite face thereof. The protect film and the separate film are employed in order to protect the polarizing plate during shipment, product inspection and other steps. In this case, the protect film, which aims at protecting the surface of the polarizing plate, is stacked on the face opposite to the face to be stacked on a liquid crystal plate. On the other hand, the separate film, which aims at covering the adhesive layer to be boned to the liquid crystal plate, is stacked on the face of the polarizing plate to be stacked on the liquid crystal face.

In a liquid crystal display, a substrate containing liquid crystals is usually provided between two polarizing plates. The protective film for polarizing plate comprising the cellulose acylate film of the invention enables the achievement of excellent display characteristics at any site. It is preferable to use the protective film in the liquid crystal cell side as an optically compensatory film together with an optically anisotropic layer. It is particularly preferable to use the protective film for polarizing plate as a protective film for polarizing plate as the outmost layer in the display side of a liquid crystal display, since a transparent hard coat layer, an antiglare layer, an antireflective layer, etc. are formed therein.

### (Liquid Crystal Display)

### (Constitution of Commonly Used Liquid Crystal Display)

Next, usage of the cellulose acylate film of the invention as a member constituting a liquid crystal display will be described.

As discussed above, the cellulose acylate film of the invention is appropriately usable as a protective film for a polarizing plate. In the case of using the thus obtained polarizing plate in a liquid crystal display, the liquid crystal display comprises a liquid crystal cell having liquid crystals between a pair of electrode substrates and two polarizing plates, one of which is provided in one-side of the cell and the other of which is provided in the other side of the cell, preferably together with at least one optically compensatory film provided between the liquid crystal cell and the polarizer.

In the case of using the cellulose acylate film as the optically compensatory film, the transmission axis of the polarizer and the slow axis of the cellulose acylate film may be located at an arbitrary angle. A liquid crystal display comprises a liquid crystal cell having liquid crystals between a pair of electrode substrates, two polarizers provided in both sides of the cell, and at least one optically compensatory film provided between the liquid crystal cell and the polarizer.

The liquid crystal layer of the liquid crystal cell is usually constructed by enclosing liquid crystals into a space formed by inserting a spacer between two substrates. A transparent electrode layer is formed as a transparent membrane containing an electrically conductive substance. The liquid crystal cell may further have a gas barrier layer, a hard coat layer or an under coat layer (employed for laminating the transparent electrode layer). These layers are usually formed on the substrate. The thickness of the liquid crystal cell substrate is generally from 50 μm to 2 mm.

### (Liquid Crystal Display Types)

The cellulose acylate film of the invention is usable in liquid crystal displays in various display modes. There have been proposed various display modes, for example, TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), ECB (electrically controlled birefringence) and HAN (hybrid aligned nematic) modes. There have been further proposed display modes obtained by split orientation of the above display modes. The cellulose acylate film of the invention is effective in liquid crystal displays in any of these display modes. It is also effective in liquid crystal displays of transmission, reflection and semi-transmission types.

### (Liquid Crystal Display of TN Type)

The cellulose acylate film of the invention may be used as the support of an optically compensatory sheet or a protective film for a polarizing plate in a TN type liquid crystal display having a liquid crystal cell in the TN mode. Liquid crystal cells in the TN mode and liquid crystal displays of the TN type have been well known for a long time. Optically compensatory sheets to be used in TN type liquid crystal displays are described in JP-A-3-9325, JP-A-6-148429, JP-A-8-50206 and JP-A-9-26572 and also reported by Mori, et al., Jpn. J. Appl. Phys., vol. 36 (1997), p. 143 and p. 1068.

### (Liquid Crystal Display of STN Type)

The cellulose acylate film of the invention may be used as the support of an optically compensatory sheet or a protective film for a polarizing plate in an STN type liquid crystal display having a liquid crystal cell in the STN mode. In general, rod-shaped liquid crystal molecules in the liquid crystal cell of a STN type liquid crystal display are twisted by 90 to 360° and the product (And) of the refractive anisotropy (Δn) of the rod-shaped liquid crystal molecule and the cell gap (d) ranges from 300 to 1500 nm. Optically compensatory sheets usable in the STN type liquid crystal displays are described in JP-A-2000-105316.

### (Liquid Crystal Display of VA Type)

The cellulose acylate film of the invention may be used as the support of an optically compensatory sheet or a protective film for a polarizing plate in a VA type liquid crystal display having a liquid crystal cell in the VA mode. It is preferable to control the Re retardation value and the Rth retardation value of the optically compensatory sheet to be used in a VA type liquid crystal display unit respectively to 0 to 150 nm and 70 to 400 nm. It is still preferable to control the Re retardation value to 20 to 70 nm. In the case of using two optically anisotropic polymer films in a liquid crystal display unit of the VA type, the Rth retardation values of the films preferably range from 70 to 250 nm. In the case of using a single optically anisotropic polymer film in a liquid crystal display unit of the VA type, the Rth retardation value of the film preferably ranges from 150 to 400 nm. Use may be also made of a liquid crystal display unit of the VA type in the split orientation system as described in, for example, JP-A-10-123576.

### (Liquid Crystal Display of IPS Type and Liquid Crystal Display of ECB Type)

The cellulose acylate film of the invention may be particularly advantageously used as the support of an optically compensatory sheet or a protective film for a polarizing plate in an IPS type liquid crystal display having a liquid crystal cell in the IPS mode or an ECB type liquid crystal display having a liquid crystal cell of the ECB mode, or a protective film of a polarizing plate therein. In these modes, a liquid crystal material is orientated almost in parallel in black display. Namely, liquid crystal molecules are orientated in parallel with the substrate plane under loading no voltage, thereby giving black display. A polarizing plate having the cellulose acylate film of the invention contributes to the enlargement in viewing angle and the improvement in contrast in these modes. In this embodiment, it is favorable to employ a polarizing plate with the use of a cellulose acylate film having a smaller optical anisotropy as the protective film located between the liquid crystal cell and the polarizing plate (i.e., the protective film in the cell side) of the polarizing plate-protective films provided above and below the liquid crystal cell, at least in one side of the liquid crystal cell. It is still favorable in these modes to control the retardation value of the optically anisotropic layer provided between the protective films of the polarizing plate and the liquid crystal cell to not more than twice of Δn·d.

### (Liquid Crystal Display of OCB Type and Liquid Crystal Display of HAN Type)

The cellulose acylate film of the invention may be also advantageously used as the support of an optically compensatory sheet or a protective film for a polarizing plate in an OCB type liquid crystal display having a liquid crystal cell in the OBC mode or a HAN type liquid crystal display having a liquid crystal cell in the HAN mode. It is preferable that an optically compensatory sheet to be used in an OCB type liquid crystal display or a HAN type liquid crystal display has a direction giving the minimum absolute retardation value neither in the optically compensatory sheet plane nor in the normal line direction. The optical properties of an optically compensatory sheet to be used in an OCB type liquid crystal display or a HAN type liquid crystal display are determined depending on the optical properties of the optically anisotropic layer, the optical properties of the support and the configuration of the optically anisotropic layer and the support. Optically compensatory sheets to be used in an OCB type liquid crystal display or a HAN type liquid crystal display are described in JP-A-9-197397 and also reported by Mori, et al., Jpn. J. Appl. Phys., Vol. 38 (1999), p. 2837.

### (Liquid Crystal Display of Reflection Type)

The cellulose acylate film of the invention may be also advantageously used as the support of an optically compensatory sheet in reflection type liquid crystal displays such as TN type, STN type, —HAN type and GH (guest-host) type. These display modes have been well known for a long time. Liquid crystal displays of the TN reflection type are described in JP-A-10-123478, WO 9848320 and Japanese Patent No. 3022477, while an optically compensatory sheet to be used in a reflection type liquid crystal display is described in WO 00-65384.

### (Other Liquid Crystal Displays)

The cellulose acylate film of the invention may be also advantageously used as the support of an optically compensatory sheet or a protective film for a polarizing plate in an ASM (axially symmetric aligned microcell) type liquid crystal display having a liquid crystal cell in the ASM mode. A liquid crystal cell of the ASM mode is characterized by being held by a resin spacer allowing to control the cell thickness from site to site. Other properties thereof are the same as liquid crystal cells in the TN mode. A liquid crystal cell in the ASM mode and an ASM type liquid crystal display are reported by Kume et al, SID 98 Digest 1089 (1998).

### (Hard Coat Film, Antiglare Film and Antireflective Film)

Furthermore, the cellulose acylate film of the invention is appropriately usable in a hard coat film, an antiglare film and an antireflective film. In order to improve the visibility of a flat panel display such as LCD, PDP, CRT or EL, any or all of a hard coat layer, an antiglare layer and an antireflective layer may be formed on one or both faces of the cellulose acylate film of the invention. Preferred embodiments of these antiglare and antireflective films are described in detail in Japan Institute of Invention and Innovation Journal of Technical Disclosure No. 2001-1745 (2001 Mar. 15, Japan Institute of Invention and Innovation), p. 54 to 57, and the cellulose acylate film of the invention is appropriately usable therein. It is also possible to form at least any one of a hard coat layer, an antiglare layer and an antireflective layer on the surface of the polarizing plate as described above to give a functional polarizing plate. Such functional polarizing plates are appropriately usable in liquid crystal displays.

### (Transparent Substrate of Liquid Crystal Cell)

Because of having an optical anisotropy close to zero and a high transparency, the cellulose acylate film of the invention is usable as a substrate for a liquid crystal glass substrate (i.e., a transparent substrate in which driving liquid crystals are enclosed) in a liquid crystal display.

Since a transparent substrate in which driving liquid crystals are enclosed should have excellent gas-barrier properties, a gas barrier layer may be formed on the surface of the cellulose acylate film of the invention, if necessary. Although the gas barrier layer is not restricted in form or material, it can be formed by depositing SiO₂ or the like on at least one face of the cellulose acylate film of the invention. Alternatively, it is also possible to form a polymer coat layer having relatively high gas barrier properties, for example, a vinylidene chloride polymer of a vinyl alcohol polymer. An appropriate method may be selected from them.

In the case of using as a transparent substrate in which driving liquid crystals are enclosed, a transparent electrode for driving liquid crystals may be provided. Although the transparent electrode is not particularly restricted, it may be formed by laminating a metallic membrane, a metal oxide membrane or the like on at least one face of the cellulose acylate film of the invention. A metal oxide membrane is preferred from the viewpoints of transparency, electrical conductivity and mechanical characteristics. Among all, a thin membrane made of indium oxide containing tin oxide as the main component together with from 2 to 15% of zinc oxide is preferably employed. These techniques are disclosed in, for example, JP-A-2001-125079 and JP-A-2000-227603.

### (Photographic Film Support)

The cellulose acylate film of the invention is applicable to supports of silver halide photographic materials and various material formulations and processing methods reported in patent documents relating to photographic sensitive materials are applicable. Regarding the techniques, JP-A 2000-105445 has detailed descriptions of color negative films, and the cellulose acylate film of the invention is favorably used in these. Also preferably, the film of the invention is applicable to supports of color reversal silver halide photographic materials, and various materials and formulations and methods for processing them described in JP-A 11-282119 are applicable to the invention.

Next, examples of the invention will be provided, though the invention is not construed as being restricted thereto.

### <Production of Cellulose Acetate Film>

### Example 1-1

### Preparation of Cellulose Acetate Solution A (CAL-1)

The composition as will be shown below was fed into a mixing tank and stirred under heating to thereby dissolving individual components, thus giving a cellulose acetate solution A. As the cellulose acylate, use was made of one having an acylation ratio (Ac:OH=2.98:0.02, wherein Ac indicates acetyl substituent; OH indicates unsubstituted hydroxyl group; and the ratio means the acylation ratio).

### {Composition of Cellulose Acetate Solution A (CAL-1)}

| | |
|---|---|
| Cellulose acetate (acylation ratio | 100 parts by mass (weight) |
| Ac = 2.98) | |
| Methylene chloride (first solvent) | 402.0 parts by mass |
| Methanol (second solvent) | 60.0 parts by mass |

### (Preparation of Mat Agent Solution (ML-1))

20 parts by mass of silica particles having a mean particle size of 16 nm (AEROSIL R972 by Nippon Aerosil) and 80 parts by mass of methanol were well stirred and mixed for 30 minutes to prepare a dispersion of silica particles. The dispersion was put into a disperser along with the following composition thereinto, and further stirred therein for at least 30 minutes to dissolve the components, thereby preparing a mat agent solution.

### {Composition of Mat Agent Solution}

| | |
|---|---|
| Dispersion of silica particles | 10.0 parts by mass |
| (mean particle size: 16 nm) | |
| Methylene chloride (first solvent) | 76.3 parts by mass |
| Methanol (second solvent) | 3.4 parts by mass |
| Cellulose acylate solution (CAL-1) | 10.3 parts by mass |

### (Preparation of Additive Solution (AD-1))

The following composition was put into a mixing tank, and heated with stirring to dissolve the components, thereby preparing an additive solution (AD-1).

### {Composition of Additive Solution (AD-1)}

| | |
|---|---|
| Rth-lowering agent (119) | 33.2 parts by mass |
| Wavelength distribution regulator (UV-102) | 5.7 parts by mass |
| Methylene chloride (first solvent) | 58.4 parts by mass |
| Methanol (second solvent) | 8.7 parts by mass |
| Cellulose acylate solution (CAL-1) | 12.8 parts by mass |

### (Production of Cellulose Acylate Film (101))

94.6 parts by mass of the cellulose acylate solution (CAL-1), 1.3 parts by mass of the mat agent solution (ML-1), and 4.1 parts by mass of the additive solution (AD-1) were separately filtered, and then mixed. Using a band caster, the mixture was cast on a band. In the above-mentioned composition, the ratio by mass of the Rth-lowering agent (119) and the wavelength distribution regulator (UV-102) to cellulose acylate was 6% by mass and 1% by mass, respectively. The film having a remaining solvent content of 80% by mass was stripped off from the band, and dried at 140° C. for 20 minutes to give a cellulose acylate film (101). The remaining solvent content of the thus-produced cellulose acylate film (101) was less than 0.1% by mass, and the thickness of the film was 80 μm.

### Example 1-2

### Preparation of Additive Solution (AD-2)

The procedure of preparing the additive solution (AD-1) was followed but using an Rth-lowering agent (265) as a substitute for the Rth-lowering agent (119) to give an additive solution (AD-2).

### (Production of Cellulose Acylate Film (101))

The procedure of preparing the cellulose acylate film (101) was followed but using the additive solution (AD-2) as a substitute for the additive solution (AD-1) to give a cellulose acylate film (102). The remaining solvent content of the thus-produced cellulose acylate film was less than 0.1% by mass, and the thickness of the film was 80 μm.

### Example 1-3

### Production of Cellulose Acylate Film (103)

The procedure of preparing the cellulose acylate film (102) was followed but stripping off the film having a remaining solvent content of 30% by mass from the band to give a cellulose acylate film (103). The remaining solvent content of the thus-produced cellose acylate film was less than 001% by mass, and the thickness of the film was 80 μm.

### Example 1-4

### Preparation of Additive Solution (AD-2′)

An additive solution (AD-2′) was prepared as in the preparation of the additive solution (AD-2) but increasing the amount of the Rth-lowering agent (265).

### {Composition of Additive Solution (AD-2′)}

| | |
|---|---|
| Rth-lowering agent (265) | 177.1 parts by mass |
| Wavelength distribution regulator (UV-102) | 5.7 parts by mass |
| Methylene chloride (first solvent) | 58.4 parts by mass |
| Methanol (second solvent) | 8.7 parts by mass |
| Cellulose acylate solution (CAL-1) | 12.8 parts by mass |

(Production of cellulose acylate film (104))

The procedure of producing the cellulose acylate film (102) was followed but using the above additive solution (AD-2′) as a substitute for the additive solution (AD-2). In this composition, the ratio by mass of the Rth-lowering agent (265) and the wavelength distribution regulator (UV-102) to cellulose acylate was 32% by mass and 1% by mass, respectively. The film having a remaining solvent content of 80% by mass was stripped off from the band, and dried at 115° C. for 20 minutes to give a cellulose acylate film (104). The remaining solvent content of the thus-produced cellulose acylate film (104) was less than 0.1% by mass, and the thickness of the film was 80 μm.

### Comparative Example 1-1

### Production of Cellulose Acylate Film (1-1)

The procedure of preparing the cellulose acylate film (101) was followed but not using the additive solution (AD-1) to give a cellulose acylate film (1-1). The remaining solvent content of the thus-produced cellulose acylate (1-1) film was less than 0.1% by mass, and the thickness of the film was 80 μm.

### Comparative Example 1-2

### Production of Cellulose Acylate Film (1-2)

The procedure of preparing the cellulose acylate film (104) was followed but stripping off the film having a remaining solvent content of 30% by mass from the band to give a cellulose acylate film (1-2). The remaining solvent content of the thus-produced cellulose acylate film (1-2) was less than 0.1% by mass, and the thickness of the film was 80 μm.

### Example 2-1

### Preparation of Cellulose Acylate Solution (CAL-2)

The procedure of preparing the cellulose acylate solution (CAL-1) was followed but using cellulose acylate containing propionyl group and having an acylation ratio 2.87 (Ac:Pro:OH=2.08:0.79:0.13) as a substitute for the cellulose acylate having an acylation ratio 2.98 (Ac:OH=2.98:0.02) to give a cellulose acylate solution (CAL-2). Pro indicates propionyl substituent.

### (Preparation of Mat Agent Solution (ML-2))

The procedure of preparing the mat agent solution (ML-1) was followed but using the cellulose acylate solution (CAL-2) as a substitute for the cellulose acylate solution (CAL-1) to give a mat agent solution (ML-2).

### (Preparation of Additive Solution (AD-3))

The procedure of preparing the additive solution (AD-1) was followed but changing the composition of the additive solution, using the cellulose acylate solution (CAL-2) as a substitute for the cellulose acylate solution (CAL-1), using ethylphthalyl ethyl glycolate (EPEG) as a substitute for the Rth-lowering agent (119), adjusting the ratio by mass thereof to cellulose acylate to 8% by mass and using no wavelength dispersion regulator to give an additive solution (AD-3).

### (Production of Cellulose Acylate Film (201))

The procedure of preparing the cellulose acylate film (101) was followed but using the cellulose acylate solution (CAL-2), the mat agent solution (ML-2) and the additive solution (AD-3) respectively as substitutes for the cellulose acylate solution (CAL-1), the mat agent solution (ML-1) and the additive solution (AD-1) to give a cellulose acylate film (201). The remaining solvent content of the thus-produced cellulose acylate film (201) was less than 0.1% by mass, and the thickness of the film was 80 μm.

### Comparative Example 2-1

### Production of Cellulose Acylate Film (2-1)

The procedure of preparing the cellulose acylate film (201) was followed but not using the additive solution (AD-3) to give a cellulose acylate film (2-1). The remaining solvent content of the thus-produced cellulose acylate film (2-1) was less than 0.1% by mass, and the thickness of the film was 80 μm.

Table 2 summarizes various physical properties of the cellulose acylate film samples of the invention (102) to (104) and the comparative samples (1-1), (1-2) and (2-1) produced above. Thus, it can be understood that each of the cellulose acylate film samples of the invention fulfills either the requirement of Tg being lower by 5 to 50° C. or requirement of the half value width of the X-ray diffraction being 110 to 300%, compared with the comparative samples not containing the additive, has Re and Rth both falling within the desired ranges, and shows improved dimensional change, modulis of elasticity, vapor transmission rate, tear strength and coefficient of humidity expansion.

TABLE 1

| | Cellulose acylate film | | | | | | | | | | | |
|---|---|---|---|---|---|---|---|---|---|---|---|---|
| | | | | | | Additive | | | | | Process conditions | |
| | | | | | | | | | | | Amount of | |
| | | Cellulose acylate | | | | | Rth-lowering | | Wavelength | | solvent | |
| | | Acylation | | | Mat | | agent | | dispersion regulator | | remaining in | Drying |
| | Sample | ratio | | Solution | solution | Solution | | Amount* | | Amount* | stripping | temp. |
| | No. | Ac | Pro | No. | No. | No. | Type | (%) | Type | (%) | (%) | (° C.) |
| Ex. 1-1 | 101 | 2.98 | — | CAL-1 | ML-1 | AD-1 | 119 | 6 | UV-102 | 1 | 80 | 140 |
| Ex. 1-2 | 102 | 2.98 | — | CAL-1 | ML-1 | AD-2 | 265 | 6 | UV-102 | 1 | 80 | 140 |
| Ex. 1-3 | 103 | 2.98 | — | CAL-1 | ML-1 | AD-2 | 265 | 6 | UV-102 | 1 | 30 | 140 |
| Ex. 1-4 | 104 | 2.98 | — | CAL-1 | ML-1 | AD-2′ | 265 | 32 | UV-102 | 1 | 80 | 115 |
| Comparative | 1-1 | 2.98 | — | CAL-1 | ML-1 | — | — | — | — | — | 80 | 140 |
| Ex. 1-1 | | | | | | | | | | | | |
| Comparative | 1-2 | 2.98 | — | CAL-1 | ML-1 | AD-2′ | 265 | 32 | UV-102 | 1 | 30 | 115 |
| Ex. 1-2 | | | | | | | | | | | | |
| Ex. 2-1 | 201 | 2.08 | 0.79 | CAL-2 | ML-2 | AD-3 | EPEG | 8 | — | — | 80 | 140 |
| Comparative | 2-1 | 2.08 | 0.79 | CAL-2 | ML-2 | — | — | — | — | — | 80 | 140 |
| Ex. 2-1 | | | | | | | | | | | | |

Amount*: a ratio by mass to cellulose acylate.

TABLE 2

| | Physical properties of cellulose acylate film | | | | | | |
|---|---|---|---|---|---|---|---|
| | | | Half value | Retardation | | | |
| | Sample | Tg | width in X-ray | Re | Rth | \|Re₄₀₀-Re₇₀₀\| | \|Rth₄₀₀-Rthe₇₀₀\| |
| | No. | (° C.) | diffraction | (nm) | (nm) | (nm) | (nm) |
| Ex. 1-1 | 101 | 142 | 1.62 | 0.02 | 3.2 | 2.1 | 15 |
| Ex. 1-2 | 102 | 150 | 2.06 | 0.05 | 1.5 | 3.5 | 16 |
| Ex. 1-3 | 103 | 152 | 1.25 | 0.01 | 1.1 | 3.2 | 14 |
| Ex. 1-4 | 104 | 114 | 1.85 | 0.2 | 6.5 | 4.5 | 15 |
| Comparative Ex. 1-1 | 1-1 | 190 | 1.35 | 3.7 | 3.7 | 15 | 39 |
| Comparative Ex. 1-2 | 1-2 | 112 | 1.06 | 0.7 | 9.6 | 5.2 | 15 |
| Ex. 2-1 | 201 | 152 | 1.73 | 0.1 | 22 | 7.5 | 25 |
| Comparative Ex. 2-1 | 2-1 | 184 | 0.92 | 4.2 | 51 | 14 | 38 |

| | Physical properties of cellulose acylate film | | | | | |
|---|---|---|---|---|---|---|
| | | | | Vapor | | Coefficient of |
| | | Dimensional | Modulus of | transmission | | humidity |
| | Sample | change | elasticity | rate (g/m² · | Tear strength | expansion |
| | No. | (%) | (kgf/mm²) | 24 hrs) | (kg cm/cm) | (10⁻⁶/% RH) |
| Ex. 1-1 | 101 | 0.08 | 427 | 1350 | 18 | 20 |
| Ex. 1-2 | 102 | 0.06 | 452 | 1420 | 22 | 24 |
| Ex. 1-3 | 103 | 0.10 | 442 | 1350 | 19 | 21 |
| Ex. 1-4 | 104 | 0.14 | 416 | 1260 | 14 | 18 |
| Comparative Ex. 1-1 | 1-1 | 0.16 | 389 | 2200 | 31 | 52 |
| Comparative Ex. 1-2 | 1-2 | 0.18 | 408 | 1230 | 12 | 18 |
| Ex. 2-1 | 201 | 0.11 | 389 | 1750 | 15 | 32 |
| Comparative Ex. 2-1 | 2-1 | 0.21 | 365 | 2350 | 29 | 45 |

### <Construction of Polarizing Plate>

The cellulose acylate films of the invention were employed as protective films for polarizing plate and evaluated in performance.

### Examples 11-1 to 11-4 and 12-1 and Comparative Examples 11-1 to 11-2 and 12-1

### Alkali Saponification

The cellulose acylate film sample (101) of the invention was dipped in an aqueous 1.5 mol/L sodium hydroxide solution at 55° C. for 2 minutes. Then, it was washed in a wash water bath at room temperature, and neutralized with 0.05 mol/L sulfuric acid at 30° C. Again, it was washed in a wash water bath at room temperature, and dried with a hot air stream at 100° C. The contact angle on the surface of the thus saponified cellulose acylate film sample was measured.

Similarly, the samples (102) to (104) and (201) of the invention and the comparative samples (1-1) to (1-2) and (2-1) were subjected to the alkali saponification and the contact angles were measured.

### (Construction of Polarizer)

A rolled polyvinyl alcohol film having a thickness of 80 μm was continuously stretched 5-fold in an aqueous iodine solution, and dried to prepare a polarizer of 20 μm in thickness.

### (Construction of Polarizing Plate)

By using an aqueous 3% by mass solution of polyvinyl alcohol “PVA-117H” (manufactured by KURARAY) as an adhesive, to sheets of the cellulose acylate film sample 101 of the invention were stacked while inserting a polarizer between them to give a polarizing plate (P1-1) protected on both faces with the film samples (101). The saponified face of each film sample (101) was provided in the polarizer side and the slow axis of the film sample (101) was located in parallel to the transmission axis of the polarizer. This polarizing plate (P1-1) sustained a sufficient stacking adhesiveness among the two saponified film samples (101) and the polarizers and a sufficient degree of polarization.

The above procedure was followed to thereby give polarizing plates with the use of the invention samples (102) to (104) and (201) and the comparative samples (1-1) to (1-2) and (2-1). The obtained polarizing plates were referred to as polarizing plates (P1-2) to (P1-4) and (P2-1) and polarizing plates (PR1-1) to (PR1-2) and (PR2-1) respectively.

Table 3 summarizes the contact angles after the saponification and the stacking adhesivenesses of the polarizing plates having the cellulose acylate film samples of the invention (P1-1) to (P1-4) and (P2-1) and the polarizing plates having the comparative samples (PR1-1) to (PR1-2) and (PR2-1). These data indicate that each of the cellulose acylate film films of the invention showed a smaller contact angle after the saponification, namely, having hydrophilic surface and thus being improved in stacking adhesiveness, compared with the comparative samples not containing the additive.

TABLE 3

| | Cellulose acylate film | | | | | | | | | |
|---|---|---|---|---|---|---|---|---|---|---|
| | | | | Additive | | | | | | |
| | | Cellulose | | | | Wavelength | | | | |
| | | acylate | | Rth-lowering | | dispersion | | Contact angle | | |
| | | Acylation | | agent | | regulator | | after | Polarizing plate | |
| | Sample | ratio | | | Amount* | | Amount* | saponification | Sample | Stacking |
| | No. | Ac | Pro | Type | (%) | Type | (%) | (°) | No. | adhesiveness |
| Ex. 11-1 | 101 | 2.98 | — | 119 | 6 | UV-102 | 1 | 24 | P1-1 | A |
| Ex. 11-2 | 102 | 2.98 | — | 265 | 6 | UV-102 | 1 | 24 | P1-2 | A |
| Ex. 11-3 | 103 | 2.98 | — | 265 | 6 | UV-102 | 1 | 25 | P1-3 | A |
| Ex. 11-4 | 104 | 2.98 | — | 265 | 32 | UV-102 | 1 | 39 | P1-4 | B |
| Comparative Ex. | 1-1 | 2.98 | — | — | — | — | — | 40 | PR1-1 | C |
| 11-1 | | | | | | | | | | |
| Comparative Ex. | 1-2 | 2.98 | — | 265 | 32 | UV-102 | 1 | 39 | PR1-2 | B |
| 11-2 | | | | | | | | | | |
| Ex. 12-1 | 201 | 2.08 | 0.79 | EPEG | 8 | — | — | 27 | P2-1 | A |
| Comparative Ex. | 2-1 | 2.08 | 0.79 | — | — | — | — | 39 | PR2-1 | C |
| 12-1 | | | | | | | | | | |

Amount*: a ratio by mass to cellulose acylate.

### (Method of Evaluating Adhesiveness)

Each protective film was peeled off repeatedly and the adhesiveness was evaluated as follows: (A) no delamination found after peeling off 50 times or more; (B) delamination found after peeling off from 30 to 50 times; and (C) delamination found after peeling off less than 30 times.

### <Liquid Crystal Display>

### (Evaluation of Cellulose Acylate Film Mounted to Liquid Crystal Display)

The cellulose acylate films of the invention were employed as constituting members and amounted to liquid crystal displays followed by evaluation in the following manner. These embodiments are examples of effective modes for using the cellulose acylate films of the invention and it should be understood that the invention is not restricted thereto.

### Example 21 and Comparative Example 21

### IPS Mode Liquid Crystal Display

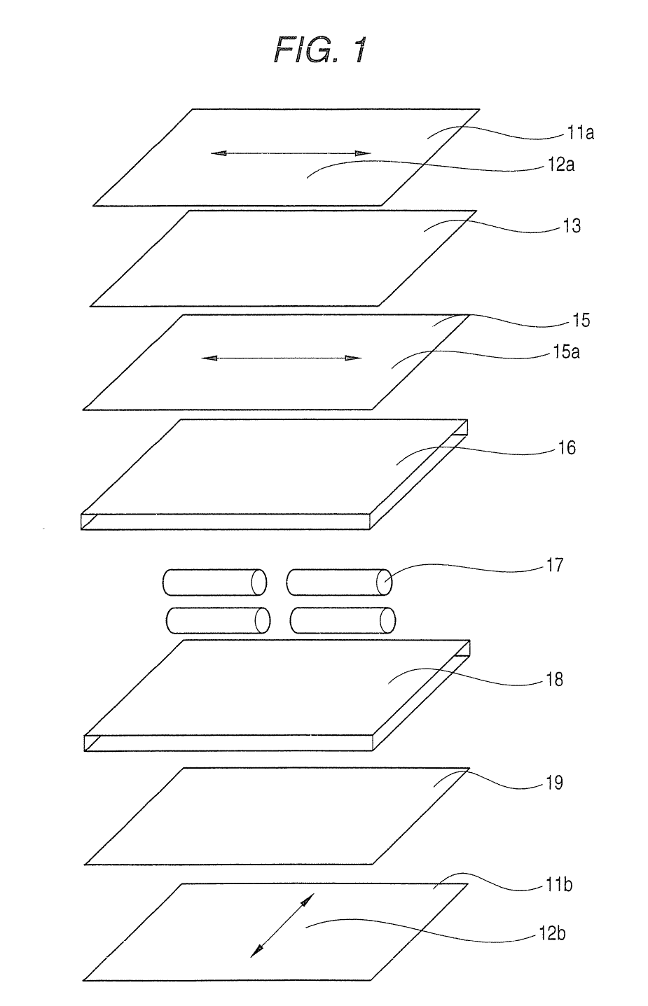

An IPS mode liquid crystal display having the constitution of FIG. 1 was constructed.

More specifically speaking, a liquid crystal cell having liquid crystal compound molecules 17 enclosed between a pair of substrates 16 and 18 was located between a pair of polarizers 11a and 11b. Then a cellulose acylate film 19 of the invention was provided between the liquid crystal cell and the polarizer in the bottom side 11b, while a first optically compensatory film 15 and a second optically compensatory film 13 were provided between the liquid crystal cell and the polarizer in the top side 11a. The relationships among transmission axes 12a and 12b of the polarizers and the slow axis of the first optically compensatory film were as mentioned in each example. Although individual constituting members are shown in FIG. 1 as being independent for convenient sake, each member may be integrated together with another member and then put into the device in some cases (for example, the cellulose acylate film 19 may be integrated as a protective film with the polarizer 11b).

Next, methods of constructing these members will be described in detail

### (Construction of IPS Mode Liquid Crystal Cell)

Electrodes were formed on a glass substrate to give intervals between adjacent electrodes of 20 μm and a polyimide film was provided thereon as an orientation film, followed by rubbing. A polyimide film was provided on one surface of another glass substrate and rubbed to give an orientation film. These two glass plates were piled up and stacked in such a manner that the orientation films faced to each other, the distance (gap: d) between the substrates was adjusted to 3.9 μm and the rubbing directions of the two glass substrates were in parallel. Next, a nematic liquid crystal composition having a refractive index anisotropy (Δn) of 0.0769 and a positive dielectric anisotropy (Δ∈) of 4.5 was enclosed therein. The dΔn value of the liquid crystal layer was 300 nm.

(Construction of Cellulose Acylate Film 19 and Bottom Side Polarizing Plate 21b)

In this Example, the cellulose acylate film 19 and the polarizer in the bottom side 11b were employed in an integrated manner as a bottom side polarizing plate 21b (not shown in the FIGURE). Namely, the polarizing plate (P1-1) constructed by sandwiching the lower polarizer 11b between two cellulose acylate film sample sheets (101) of Example 1 or the polarizing plate (PR1-1) constructed in the same manner using the comparative sample (1-1) was employed as the bottom side polarizing plate 21b.

(Construction of Second Optically Compensatory film 13)

Fujitak TD80UF (manufactured by FUJI PHOTOFILM Co., Ltd.) was longitudinally uniaxially 15%-stretched at 150° C. to give an optically compensatory film 13 (optical characteristics: Re=5 nm, Rth=70 nm).

### (Construction of First Optically Compensatory Film 15)

### (Formation of Orientation Film)

After saponifying the surface of the second optically compensatory film constructed above, a coating solution for orientation film having the following composition was applied to the film with a wire bar coater at a ratio of 20 μL/m². Then, it was dried under a hot air stream at 60° C. for 60 seconds and subsequently a hot air stream at 100° C. for 120 seconds to thereby form a film. The film thus formed was rubbed in a direction parallel to the slow axis of the film to thereby give an orientation film.

### (Composition of Coating Solution for Orientation Film)

| | |
|---|---|
| Denatured polyvinyl alcohol having the | 10 parts by mass |
| following composition | |
| Water | 371 parts by mass |
| Methanol | 119 parts by mass |
| Glutaraldehyde | 0.5 part by mass |
| Tetetramethylammonium fluoride | 0.3 part by mass |

### Denatured Polyvinyl Alcohol

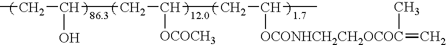

### (Formation of Optically Anisotropic Layer)

On the thus oriented film, a solution prepared by dissolving 1.8 g of the following discotic liquid crystal compound, 0.2 g of ethylene oxide-denatured trimethylolpropane triacrylate (V#360, manufactured by OSAKA ORGANIC CHEMICAL INDUSTRIES), 0.06 g of a photopolymerization initiator (Irgacure 907, manufactured by Ciba-Geigy), 0.02 g of a sensitizer (Kayacure DETX, manufactured by NIPPON KAYAKU Co., Ltd.) and 0.01 g of the following perpendicular orientation agent in the atmosphere-interface side in 3.9 g of methyl ethyl ketone was coated with a #5 wire bar. The obtained product was stacked on a metallic frame and heated in a thermostat at 125° C. for 3 minutes to thereby orientate the discotic liquid crystal compound, Subsequently, it was UV-irradiated at 100° C. with the use of a high-pressure mercury lamp at 120 W/cm for 30 seconds to thereby crosslink the discotic liquid crystal compound and then cooled to room temperature by allowing to stand to thereby form an optically anisotropic layer. Thus, a phase contrast film having the first optically compensatory film formed on the second optically compensatory film was constructed.

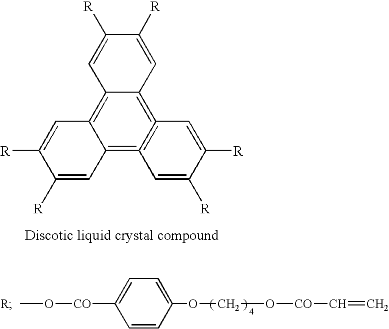

### Fluorinated Polymer (Perpendicular Orientation Agent in the Atmosphere-Interface Side)

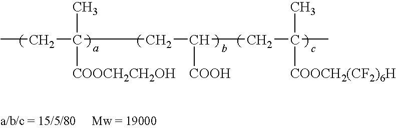

The optical characteristics of the discotic liquid crystal optically anisotropic layer (the first optically compensatory film) alone were calculated by measuring the incident light angle dependency of Re of the phase contrast film constructed above and subtracting the predetermined contribution of the second optically compensatory film therefrom. As a result, Rₑ was 100 nm, Rth was −55 nm and the average incline angle of liquid crystals was 89.9°. Thus, it was confirmed that the discotic liquid crystals were oriented perpendicularly to the film face. The slow axis direction was parallel with the rubbing direction.

(Construction of Top Side Polarizing Plate 21a)

The stretched polyvinyl alcohol film was allowed to absorb iodine to give the top side polarizer 11a. On one surface of this polarizer, a cellulose acetate film “FUJITACK TD80UF” (manufactured by FUJI PHOTOFILM Co., Ltd.) was stacked, on the other surface of the polarizer 11a, the phase contrast film was stacked in such a manner that the second optically compensatory film 13 was located in the polarizer 11a side, thereby constructing an integrated top side polarizing plate 21a (not shown in the FIGURE) integrated together with the optically anisotropic layer.

### (Construction of Liquid Crystal Display)

The top side polarizing plate 21a as described above was stacked on an IPS mode cell in such a manner that the first optically compensatory film side was provided in the liquid crystal cell side. The two slow axes of the IPS mode cell liquid crystal layer were located in parallel with the transmission axis 12a of the polarizer 11a. Next, the bottom side polarizing plate 21b constructed above was stacked in such a manner that the transmission axis 12b of the bottom side polarizer 11b was orthogonal to the transmission axis 12a of the top side polarizer 11a, thereby constructing a liquid crystal display.

(Measurement of Light Leakage from the Liquid Crystal Display Thus Constructed)

In the liquid crystal displays thus constructed, light leakage in black display observed from an angle of 60° in the left face direction was measured. In the case of using each of the cellulose acylate films of the invention, light leakage was extremely compared with the devices using the comparative samples. Thus, it can be understood that the cellulose acylate films of the invention are excellent in contrast (i.e., showing little light leakage) and viewing angle characteristics in color display, when employed in liquid crystal displays.

### <Construction of Optically Compensatory Film>

### Example 31

By using the cellulose acylate film sample (101) of the invention, an optically compensatory film sample was constructed in accordance with the method of Example 1 in JP-A-2003-315541.

### (Formation of Optically Anisotropic Layer)

A polyimide having a mass-average molecular weight (Mw) of 70,000 and Δn of about 0.04, which had been synthesized from 2,2′-bis(3,4-dicarboxyphenyl)hexafluoropropane dianhydride with 2,2′-bis(trifluoromethyl)-4,4′-diaminobiphenyl (TFMB), was dissolved in cyclohexanone to give a 25% by mass solution. This solution was applied to the cellulose acylate film sample (101) (thickness: 80 μm) prepared in Example 1-1. After heating to 100° C. for 10 minutes, it was longitudinally uniaxially 15%-stretched at 160° C. to give an optically compensatory film in which a polyimide film of 6 μm in thickness was formed as the optically anisotropic layer on the cellulose acylate film sample (101) of the invention.

The optical characteristics of this optically compensatory film were as follows: Re=72 nm, Rth=220 nm, shift angle in orientation axis≦+0.3°.

### Comparative Example 31

The procedure of Example 31 was followed but using the comparative sample (1-1) (thickness: 80 μm) as a substitute for the cellulose acylate film sample (101) of the invention to thereby give an optically compensatory film in which a polyimide film of 6 μm in thickness was formed as the optically anisotropic layer on the comparative cellulose acylate film sample (1-1). The optical characteristics of this optically compensatory film were as follows: Re=75 nm, Rth=257 nm.

### (Evaluation of Mounting on VA Type Liquid Crystal Display)

The optically compensatory films obtained in Example 31 and Comparative Example 31 were each alkali saponified in the face having no polyimide film stacked thereon. Then it was stacked directly on a polarizer with the use of a polyvinyl alcohol-based adhesive. The stacking was conducted so that the slow axis direction of the optically compensatory film was orthogonal to the absorption axis of the polarizer. Next, the optically compensatory film was stacked on a VA liquid crystal panel with a pressure-sensitive adhesive so that the optically compensatory film was located in the liquid crystal side. In the opposite side of the liquid crystal, a polarizing plate alone was stacked on the VA liquid crystal panel via a pressure-sensitive adhesive so that the absorption axes of the polarizing plates were orthogonal to each other.

The viewing angle characteristics of the liquid crystal displays thus obtained were measured. The polar angle, at which the contrast ratio of black display to white display in the 45° direction attains 20 or less (the polar angle of a perpendicular line to the panel being referred to as 0° C. and the polar angle increasing with an increase in diagonal angle), was determined. The case of the optically compensatory film obtained by using the cellulose acylate film sample (101) of the invention sustained excellent viewing angle characteristics (i.e., contrast 20 or higher) up to the polar angle 80°, while the coco obtained by using the comparative sample (1-1) showed poor viewing angle properties (ice., polar angle 30°). Thus, it was clarified that the cellulose acylate film of the invention was highly usable as a phase contrast film for VA mode.

Table 4 summarizes the results of Example 21 and Comparative Example 21 and Example 31 and Comparative Example 31.

Compared with the comparative sample (1-1) not containing the additives, the cellulose acylate film sample (101) of the invention has small Re, Small Rth, narrow wavelength dispersion of Re and narrow wavelength dispersion of Rth. Owing to these characteristics, the cellulose acylate film of the invention is effective in lessening color change from an angle and relieving light leakage in black display when employed in IPS mode liquid crystal displays. It is also found out that the cellulose acylate film of the invention can improve the contrast viewing angle characteristics when employed in VA mode liquid crystal displays.

TABLE 4

| | | | | | | | | Liquid display device | | | |
|---|---|---|---|---|---|---|---|---|---|---|---|
| Cellulose acylate film | | | | | | | | IPS mode | | | |
| | | Additive | | | | | | | Light | VA mode | |
| | | Rth- | Wavelength | Optical characteristics | | | | | leakage | | Contrast |
| | Sample | lowering | dispersion | Re | Rth | \|Re₄₀₀-Re₇₀₀\| | \|Rth₄₀₀-Rth₇₀₀\| | | from | | viewing angle |
| | No. | agent | regulator | (nm) | (nm) | (nm) | (nm) | | angle | | characteristics |
| Ex. 1-1 | 101 | 119 | UV-102 | 0.02 | 3.2 | 2.1 | 15 | Ex. 21 | No | Ex. 31 | 78° |
| Comparative | 1-1 | — | — | 3.7 | 37 | 15 | 39 | Comparative | Yes | Comparative | 29° |
| Ex. 1-1 | | | | | | | | Ex. 21 | | Ex. 31 | |

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-111171 filed Apr. 7, 2005, the contents of which are incorporated herein by reference.

1. A cellulose acylate film comprising an additive, the cellulose acylate film fulfilling at least one of requirements (1) and (2):
(1) the cellulose acylate film has a glass transition temperature lower by 5 to 50° C. than that of a cellulose acylate film not containing the additive; and
(2) the cellulose acylate film having been heated at 200° C. for 3 hours has a half value width of a diffraction peak at 20 of 10 to 15° in an X-ray diffraction pattern thereof, the half value width being 110 to 300% of a half value width of a cellulose acylate film not containing the additive and having been heated at 200° C. for 3 hours, and
the cellulose acylate film further fulfilling numerical formulae (1) and (2):
0≦Re₆₃₀≦10, and |Rth₆₃₀|≦25 Numerical formulae (1)

|Re₄₀₀−Re₇₀₀|≦10, and |Rth₄₀₀−Rth₇₀₀|≦35 Numerical formulae (2)
wherein Re(λ) indicates an in-plane retardation by nm of the cellulose acylate film at a wavelength of λ nm; and Rth(λ) indicates a thickness-direction retardation by nm of the cellulose acylate film at a wavelength of λ nm.

2. The cellulose acylate film according to claim 1, which has an absolute value of dimensional change after standing at 60° C. and 90% for 24 hours, the absolute value being 5 to 90% with respect to an absolute value of dimensional change of a cellulose acylate film not containing the additive.

3. The cellulose acylate film according to claim 1, which has a modulus of elasticity of 101 to 150% with respect to a modulus of elasticity of a cellulose acylate film not containing the additive.

4. The cellulose acylate film according to claim 1, which has a vapor transmission rate of 30 to 90% with respect to a vapor transmission rate of a cellulose acylate film not containing the additive.

5. The cellulose acylate film according to claim 1, which has a contact angle after alkali saponification of 95% or less with respect to a contact angle after alkali saponification of a cellulose acylate film not containing the additive.

6. The cellulose acylate film according to claim 1, which has a tear strength of 95% or less with respect to a tear strength of a cellulose acylate film not containing the additive.

7. The cellulose acylate film according to claim 1, which has a coefficient of humidity expansion of 95% or less with respect to a coefficient of humidity expansion of a cellulose acylate film not containing the additive.

8. The cellulose acylate film according to claim 1, which is obtained from a starting polymer having an acylation ratio of 2.85 to 3.00.

9. The cellulose acylate film according to claim 1, wherein the additive is a compound capable of lowering Rth_{λ} in such a range as fulfilling numerical formulae (3) and (4):
(Rth_{λA}−Rth_{λ0})/A≦<−1.0 Numerical formula (3)
0.01≦A≦30 Numerical formula (4)
wherein Rth_{λA} indicates Rth_{λ} by nm of a cellulose acylate film containing A % by mass of the compound capable of lowering Rth_{λ}; Rth₀ indicates Rth_{λ} by nm of a cellulose acylate film not containing the compound capable of lowering Rth_{λ}; and A indicates an amount by mass % of the compound capable of lowering Rth_{λ} referring a mass of a starting polymer of the cellulose acylate film as to 100.

10. The cellulose acylate film according to claim 1, which the additive is a compound capable of lowering |Re₄₀₀−Re₇₀₀| and |Rth₄₀₀−Rth₇₀₀| in an amount of 0.01 to 30% by mass based on a solid content of a starting polymer of the cellulose acylate film.

11. The cellulose acylate film according to claim 1, which has a film thickness of 10 to 120 μm.

12. A method of producing a cellulose acylate film according to claim 1, which comprises:
casting a cellulose acylate solution containing a solvent on a support to provide a film,
stripping off the film from the support; and
drying the film,
wherein the film in the stripping has an amount of the solvent of 50 to 200%.

13. A method of producing a cellulose acylate film according to claim 1, which comprises:
casting a cellulose acylate solution containing a solvent on a support to provide a film,
stripping off the film from the support; and
drying the film at a temperature of 120 to 160° C.

14. An optically compensatory film comprising:
a cellulose acylate film according to claim 1; and
an optically anisotropic layer having Re₆₃₀ of 0 to 200 nm and |Rth₆₃₀| of 0 to 400 nm.

15. A polarizing plate comprising: a polarizer; and a protective film of a cellulose acylate film according to claim 1.

16. A liquid crystal display comprising a cellulose acylate film according to claim 1.
